(19) United States
(12) Patent Application Publication
(10) Pub. No.: US 2026/0032559 A1
(43) Pub. Date: Jan. 29, 2026

(54) MULTI-PATH COMMUNICATION METHOD AND APPARATUS

(71) Applicant: FUJITSU LIMITED, Kawasaki-shi (JP)

(72) Inventors: Guorong LI, Beijing (CN); Meiyi JIA, Beijing (CN); Su YI, Beijing (CN); Xin WANG, Beijing (CN)

(73) Assignee: FUJITSU LIMITED, Kawasaki-shi (JP)

(21) Appl. No.: 19/346,755

(22) Filed: Oct. 1, 2025

Related U.S. Application Data
(63) Continuation of application No. PCT/CN2023/086607, filed on Apr. 6, 2023.

(51) Int. Cl. H04W 40/24; H04L 45/24; H04W 40/36; H04W 72/40

(52) U.S. Cl. CPC H04W 40/248; H04L 45/24; H04W 40/36; H04W 72/40

(57) ABSTRACT

A multi-path communication apparatus, configured in a remote terminal equipment, includes: a receiver configured to receive a radio resource control reconfiguration message for adding or changing an indirect path transmitted by a network device via a direct path; and a transmitter configured to transmit a radio resource control reconfiguration complete message to the network device via the direct path, wherein, a first timer is started when the remote terminal equipment receives the radio resource control reconfiguration message for adding or changing an indirect path; and, the first timer is stopped under a first condition, the first condition includes: the remote terminal equipment receives indication information transmitted by the relay terminal equipment.

### CROSS-REFERENCE TO RELATED APPLICATION

This application is a continuation application under 35 U.S.C. 111 (a) of International Patent Application PCT/CN2023/086607 filed on Apr. 6, 2023, and designated the U.S., the entire contents of which are incorporated herein by reference.

### FIELD

This disclosure relates to the field of communication.

### BACKGROUND

In Release 18 of the 3rd Generation Partnership Project (3GPP), multi-path schemes are studied and supported. A scenario of the multi-path may be: a remote user equipment (UE) is connected to the same network device (e.g. a gNB) by using a direct path and an indirect path. For example, the direct path may be that the remote terminal equipment is connected directly to the network device via a Uu interface, and the indirect path may be that the remote user equipment is connected to the network device via a layer 2 (L2) UE-to-Network relay, such as being connected to the network device via a relay UE.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in multi-path schemes, in a scenario where an indirect path is added or changed, there is currently no solution for how a remote terminal equipment transmits an RRC reconfiguration complete message to a network device.

In order to solve at least one of the above problems, embodiments of this disclosure provide a multi-path communication method and apparatus.

According to one aspect of the embodiments of this disclosure, there is provided a multi-path communication apparatus, configured in a remote terminal equipment, the apparatus including: a receiving unit configured to receive an RRC reconfiguration message for adding or changing an indirect path transmitted by a network device via a direct path; and a transmitting unit configured to transmit an RRC reconfiguration complete message to the network device via the direct path.

According to another aspect of the embodiments of this disclosure, there is provided a multi-path communication apparatus, configured in a remote terminal equipment, the apparatus including: a processing unit configured to, in a case of a second condition or in a case where a second timer is stopped, deem that adding or changing an indirect path is successful, or execute an operation related to success of adding or changing an indirect path.

According to a further aspect of the embodiments of this disclosure, there is provided a multi-path communication apparatus, configured in a remote terminal equipment, the apparatus including: a processing unit configured to, in a case of failure in adding or changing an indirect path, transmit failure information to a network device or initiate an RRC reestablishment procedure.

According to still another aspect of the embodiments of this disclosure, there is provided a multi-path communication method, applicable to a remote terminal equipment, the method including: receiving, by the remote terminal equipment via a direct path, an RRC reconfiguration message for adding or changing an indirect path transmitted by a network device; and transmitting an RRC reconfiguration complete message by the remote terminal equipment to the network device via the direct path.

According to yet another aspect of the embodiments of this disclosure, there is provided a multi-path communication method, applicable to a remote terminal equipment, the method including: in a case of a second condition or in a case where a second timer is stopped, deeming by the remote terminal equipment that adding or changing an indirect path is successful, or executing an operation related to success of adding or changing an indirect path by the remote terminal equipment.

According to yet further aspect of the embodiments of this disclosure, there is provided a multi-path communication method, applicable to a remote terminal equipment, the method including: in a case of failure in adding or changing an indirect path, transmitting failure information by the remote terminal equipment to a network device or initiating an RRC reestablishment procedure.

According to yet another aspect of the embodiments of this disclosure, there is provided a multi-path communication apparatus, configured in a network device, the apparatus including: a transmitting unit configured to transmit an RRC reconfiguration message for adding or changing an indirect path to a remote terminal equipment via a direct path; and a receiving unit configured to receive via the direct path an RRC reconfiguration complete message transmitted by the remote terminal equipment.

According to yet another aspect of the embodiments of this disclosure, there is provided a multi-path communication apparatus, configured in a network device, the apparatus including: a processing unit configured to, in a case of a second condition or in a case where a second timer is stopped, deem that adding or changing an indirect path is successful, or execute an operation related to success of adding or changing an indirect path.

According to a further aspect of the embodiments of this disclosure, there is provided a multi-path communication apparatus, configured in a network device, the apparatus including: a receiving unit configured to receive failure information transmitted by a terminal equipment in a case of failure in adding or changing an indirect path.

According to still another aspect of the embodiments of this disclosure, there is provided a multi-path communication method, applicable to a network device, the method including: transmitting an RRC reconfiguration message for adding or changing an indirect path by the network device to a remote terminal equipment via a direct path; and receiving via the direct path an RRC reconfiguration complete message transmitted by the remote terminal equipment.

According to still another aspect of the embodiments of this disclosure, there is provided a multi-path communication method, applicable to a network device, the method including: in a case of a second condition or in a case where a second timer is stopped, deeming by the network device that adding or changing an indirect path is successful, or executing an operation related to success of adding or changing an indirect path by the network device.

According to still another aspect of the embodiments of this disclosure, there is provided a multi-path communication method, applicable to a network device, the method including: receiving, by the network device, failure information transmitted by a terminal equipment in a case of failure in adding or changing an indirect path.

According to still another aspect of the embodiments of this disclosure, there is provided a remote terminal equipment, including a memory and a processor, the memory storing a computer program, and the processor being configured to execute the computer program to carry out the multi-path communication methods at the remote terminal equipment side described above.

According to yet another aspect of the embodiments of this disclosure, there is provided a network device, including a memory and a processor, the memory storing a computer program, and the processor being configured to execute the computer program to carry out the multi-path communication methods at the network device side described above.

According to still another aspect of the embodiments of this disclosure, there is provided a communication system, including the above-described network device and/or the above-described remote terminal equipment.

One of the advantages of the embodiments of this disclosure exists in that the remote terminal equipment receives a radio resource control reconfiguration message for adding or changing an indirect path transmitted by the network device via a direct path, and transmits a radio resource control reconfiguration complete message to the network device via the direct path, which is helpful for the network device learn whether the remote terminal equipment successfully performs the configuration in the RRC reconfiguration message or whether successfully adds or changes the indirect path, so that the remote terminal equipment and the network device have consistent understanding of the configuration of the remote terminal equipment, thereby avoiding subsequent configuration conflicts or configuration errors.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of a multi-path scenario of an embodiment of this disclosure;

FIG. 3 is a schematic diagram of a structure of a multi-path protocol stack of an embodiment of this disclosure;

FIGS. 4, 8, 11 and 13-15 are schematic diagrams of the multi-path communication methods of embodiments of this disclosure;

FIGS. 5-7, 9-10 and 12 are schematic diagrams of processes of information exchange of embodiments of this disclosure;

FIGS. 16-21 are schematic diagram of the multi-path communication apparatuses of embodiments of this disclosure;

FIG. 22 is a schematic diagram of a structure of the remote terminal equipment of an embodiment of this disclosure; and

FIG. 23 is a schematic diagram of a structure of the network device of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, a machine to machine (M2M) terminal, and a terminal supporting sidelink communication, etc.

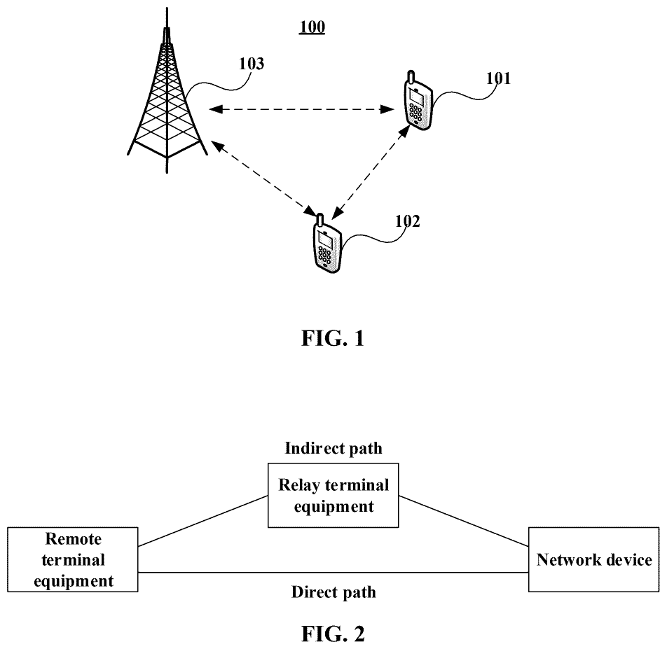

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment. FIG. 1 is a schematic diagram of a communication system of an embodiment of this disclosure, illustrating a case taking a remote terminal equipment, a relay terminal equipment and a network device as an example. As shown in FIG. 1, the communication system 100 may include a remote terminal equipment 101, a relay terminal equipment 102 and a network device 103. The remote terminal equipment 101 is connected to the network device 103 via a direct path and an indirect path. For the sake of simplicity, description is given in FIG. 1 by taking two terminal equipments (one remote terminal equipment and one relay terminal equipment) and one network device as an example; however, the embodiment of this disclosure is not limited thereto.

In the embodiment of this disclosure, existing services or services that may be implemented in the future may be performed between the network device 103 and the remote terminal equipment 101 and the relay terminal equipment 102. For example, such services may include but not limited to an enhanced mobile broadband (eMBB), massive machine type communication (MTC), ultra-reliable and low-latency communication (URLLC), etc.

FIG. 2 is a schematic diagram of a multi-path scenario of the embodiment of this disclosure. As shown in FIG. 2, in the embodiment of this disclosure, the remote terminal equipment may simultaneously communicate with the network device (such as a gNB) via a direct path and an indirect path. For example, the remote terminal equipment may communicate with a network device via a Uu interface (the direct path) and communicate with a network device via the relay terminal equipment (the indirect path).

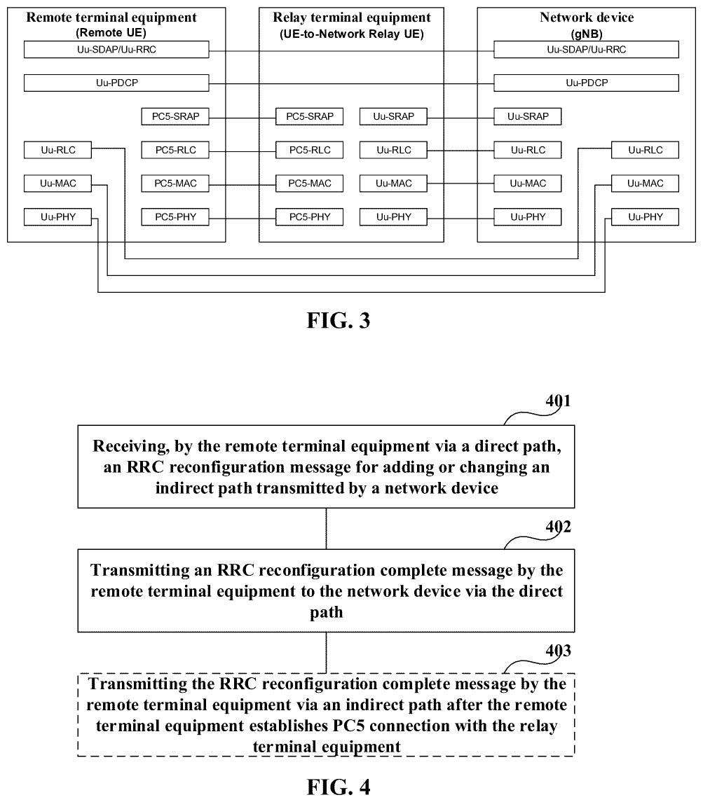

FIG. 3 is a schematic diagram of a structure of a multi-path protocol stack of the embodiment of this disclosure. As shown in FIG. 3, the direct path between the remote terminal equipment and the network device uses a Uu interface protocol stack, and the indirect path between the remote terminal equipment and the network device is transmitted via L2 UE-to-Network relay, using the PC5 interface and a Uu interface protocol stack.

In some embodiments, as shown in FIG. 3, an RRC (radio resource control) layer, a service data adaptation protocol (SDAP) layer and a packet data convergence protocol (PDCP) layer in the remote terminal equipment are equivalent to an RRC layer, an SDAP layer and a PDCP layer in the network device, and data of the PDCP layer of the remote terminal equipment may be transmitted to the network device via the indirect path passing the relay user equipment. For example, a PDCP PDU (protocol data unit) of the remote terminal equipment may be transmitted to the relay UE via a PC5-SRAP (sidelink relay adaptation protocol), a PC5-RLC, a PC5-MAC and a PC5-PHY through a sidelink, and then the relay UE transmits the data to a gNB via its own Uu interface protocol stack (a Uu SRAP, a Uu RLC, a Uu MAC, and a Uu PHY). The gNB side receives the data from a peer Uu interface protocol stack of the relay UE, and transmits the data to the Uu-PDCP of the gNB for processing.

Or, data of the PDCP layer of the remote terminal equipment may be transmitted to the network device via a direct path. For example, the PDCP PDU of the remote terminal equipment may be transmitted to the gNB via a Uu RLC, a Uu MAC, and a Uu PHY. The gNB side receives the data from a peer Uu interface protocol stack of the remote UE, and transmits the data to the Uu-PDCP of the gNB for processing.

In some embodiments, in the direct path and/or the indirect path, there may be one or more RLC (radio link control) entities (Uu RLC entities or PC5 RLC entities) associated with a PDCP entity of a radio bearer.

In some embodiments, as shown in FIG. 3, in the protocol stack of the gNB side, more than one Uu MAC entities may be used to process data of the remote terminal equipment and the relay user equipment; however, this disclosure is not limited thereto, and one Uu MAC entity may be used to process data of the remote terminal equipment and the relay user equipment.

In some embodiments, as shown in FIG. 3, in the protocol stack of the remote terminal equipment, a PC5-MAC entity and a Uu-MAC entity may be used to process data of the indirect path and the direct path; however, this disclosure is not limited thereto, and an MAC entity may also be used to execute operations of PC5-MAC and Uu-MAC.

In some embodiments, as shown in FIG. 3, transmitting via a direct path refers to, for example, that the PDCP layer transmits data to a Uu RLC bearer or channel or entity, and transmitting via an indirect path refers to, for example, that the PDCP layer transmits data to the SRAP entity and then transmits via the RLC bearer or channel or entity of PC5.

In some embodiments, the data may be PDCP SDUs (service data units) or PDCP PDUs or RLC SDUs, etc.

In some embodiments, the gNB connected by the remote terminal equipment via a direct path and the gNB connected via an indirect path are identical gNB. A cell connected by the remote terminal equipment via a direct path and a cell connected via an indirect path are identical cell; or, the cell connected by the remote terminal equipment via a direct path and the cell connected via an indirect path are different cells, wherein the different cells may be intra-frequency cells or inter-frequency cells.

In some embodiments, in the multi-path scenario, the following situations may be supported:
A. The remote UE operating only on the direct path adds the indirect path under the same gNB;
B. The remote UE operating only on the indirect path adds the direct path under the same gNB;
C. The remote UE operating in multi-path releases the indirect path;
D. The remote UE operating in multi-path releases the direct path;
G. The remote UE operating in multi-path changes to a new relay UE for the indirect path while keeping the direct path under the same gNB. FFS if this case would be supported via separate release-and-add (A+C in separate reconfigurations) or a single switch procedure (e.g. similar to i2i service continuity);
E. The remote UE operating in multi-path changes the direct path to a different cell of the same gNB while using the serving relay UE for the indirect path under the same gNB;

Change of direct path while keeping the indirect path can be done with a release-and-add in a single RRC message. This does not exclude a gNB implementation from using separate release and add procedures instead.

Change of indirect path while keeping the direct path can be done with a release-and-add in a single RRC message. This does not exclude a gNB implementation from using separate release and add procedures instead.

Implementations of the embodiments of this disclosure shall be described below with reference to the accompanying drawings. These implementations are illustrative only, and are not intended to limit this disclosure.

### Embodiment of a First Aspect

The embodiment of this disclosure provides a multi-path communication method, applicable to a remote terminal equipment. FIG. 4 is a schematic diagram of the multi-path communication method of the embodiment of this disclosure. As shown in FIG. 4, the method includes:
401: receiving, by the remote terminal equipment via a direct path, an RRC reconfiguration message for adding or changing an indirect path transmitted by a network device; and
402: transmitting an RRC reconfiguration complete message by the remote terminal equipment to the network device via the direct path.

It should be noted that FIG. 4 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

According to the above embodiment, the remote terminal equipment receives a radio resource control reconfiguration message for adding or changing an indirect path transmitted by the network device via a direct path, and transmits a radio resource control reconfiguration complete message to the network device via the direct path, which is helpful for the network device learn whether the remote terminal equipment successfully performs the configuration in the RRC reconfiguration message or whether successfully adds or changes the indirect path, so that the remote terminal equipment and the network device have consistent understanding of the configuration of the remote terminal equipment, thereby avoiding subsequent configuration conflicts or configuration errors.

For example, for situation A (adding an indirect path), the remote terminal equipment receives via the direct path the RRC reconfiguration message for adding an indirect path transmitted by the network device, the RRC reconfiguration message including an identifier of the relay terminal equipment and a configuration of the SRAP; For situation G (changing an indirect path, for example, releasing an original indirect path and adding a new indirect path, wherein the newly-added indirect path may be similar to that in situation A), the remote terminal equipment receives via the direct path the RRC reconfiguration message for adding an indirect path transmitted by the network device, the RRC reconfiguration message including releasing an original SRAP configuration, the identifier of the relay terminal equipment, and an SRAP configuration.

After receiving the RRC reconfiguration message for adding an indirect path or the RRC reconfiguration message for changing an indirect path, the remote terminal equipment needs to transmit the RRC reconfiguration complete message to the network device at an appropriate time. In a case where a signaling radio bearer (SRB) carrying the RRC reconfiguration complete message is configured on the direct path, such as in a case where SRB1 or split SRB1 or duplication SRB1 is configured on the direct path, the remote terminal equipment transmits the RRC reconfiguration complete message via the direct path.

Transmitting the RRC reconfiguration complete message by the remote terminal equipment may be equivalently replaced with submitting the RRC reconfiguration complete message by an RRC layer of the remote terminal equipment to a lower layer for transmission, or deeming by the remote terminal equipment that a procedure of adding or changing a direct path is successful.

In some embodiments, the RRC reconfiguration complete message may be transmitted at various times after the remote terminal equipment receives the RRC reconfiguration message transmitted by the network device. For example, the RRC reconfiguration complete message may be transmitted at one of the following times: after the remote terminal equipment executes corresponding configurations according to the RRC reconfiguration message; after PC5 connection between the remote terminal equipment and a relay terminal equipment is set up; after the remote terminal equipment transmits a PC5-RRC message to a relay terminal equipment; after the remote terminal equipment transmits PC5-RRC trigger to a relay terminal equipment; after the remote terminal equipment receives indication information transmitted by a relay terminal equipment; or after a first timer used for a procedure of adding or changing an indirect path is stopped.

In some embodiments, that the remote terminal equipment executes corresponding configurations according to the RRC reconfiguration message may include an operation related to adding an indirect path, such as establishing an SRAP configuration.

In some embodiments, that the remote terminal equipment executes corresponding configurations according to the RRC reconfiguration message may include an operation related to changing an indirect path, such as releasing an original SRAP configuration and adding a new SRAP configuration, or changing the original SRAP configuration, etc.

In some embodiments, that PC5 connection between the remote terminal equipment and a relay terminal equipment is set up may include transmitting a direct communication request or a direct communication response by a V2X (Vehicle to Everything) layer, etc. The PC5 connection may also be expressed as PC5-RRC connection.

In some embodiments, the PC5-RRC message transmitted by the remote terminal equipment to the relay terminal equipment may include at least one of the following: a remote UE information sidelink (RemoteUEInformationSidelink), an RRC reconfiguration sidelink reconfiguration complete sidelink (RRCReconfigurationSidelink), an RRC (RRCReconfigurationCompleteSidelink), a UE assistance information sidelink (UEAssistanceInformationSidelink), or a new PC5-RRC message.

In some embodiments, the PC5-RRC trigger is used to cause the relay terminal equipment to enter an RRC_Connected state. For example, in the scenario of adding or changing an indirect path, the relay terminal equipment may possibly be in an RRC_Idle state or an RRC_Inactive state. The remote terminal equipment may transmit the PC5-RRC trigger to the relay terminal equipment, thereby causing the relay terminal equipment to enter the RRC_Connected state, and enabling the relay terminal equipment to provide relay services to the remote terminal equipment.

In some embodiments, the indication information transmitted by the relay terminal equipment to the remote terminal equipment may include information that the relay terminal equipment enters the RRC_Connected state. In other words, after the remote terminal equipment confirms that the relay terminal equipment has entered the RRC_Connected state, it transmits the RRC reconfiguration complete message to the network device. For example, the indication information may be a PC5-RRC message.

In some embodiments, the first timer may be started when the remote terminal equipment receives the RRC reconfiguration message for adding or changing an indirect path; however, this disclosure is not limited thereto, and the first timer may also be started at other times.

In some embodiments, the first timer may be stopped under a first condition, the first condition including at least one of the following: the remote terminal equipment transmits a PC5-RRC message to the relay terminal equipment; the remote terminal equipment transmits a PC5-S message to the relay terminal equipment; the remote terminal equipment transmits data of a radio bearer via the relay terminal equipment; a PC5-RRC message and/or a PC5-S message is/are successfully transmitted to the relay terminal equipment; the remote terminal equipment set up PC5 connection with the relay terminal equipment; or the remote terminal equipment receives indication information transmitted by the relay terminal equipment.

In some embodiments, the PC5-RRC message transmitted by the remote terminal equipment to the relay terminal equipment may include at least one of the following: a remote UE information sidelink (RemoteUEInformationSidelink), an RRC reconfiguration sidelink (RRCReconfigurationSidelink), an RRC reconfiguration complete sidelink (RRCReconfigurationCompleteSidelink), a UE assistance information sidelink (UEAssistanceInformationSidelink), or a new PC5-RRC message.

In some embodiments, the PC5-S message transmitted by the remote terminal equipment to the relay terminal equipment may include at least one of the following: a discovery-related message; or a direct communication request/response message.

In some embodiments, the discovery-related message may include at least one of the following: a discovery solicitation, or a discovery response.

In some embodiments, that a PC5-RRC message and/or a PC5-S message is/are successfully transmitted to the relay terminal equipment may include that the remote terminal equipment receives feedback information from the relay terminal equipment regarding the PC5-RRC message and/or PC5-S message, such as acknowledgement from the PC5-RLC layer.

In some embodiments, the data of the radio bearer may be data of a data radio bearer (DRB) or signaling of a signaling radio bearer (SRB), such as RRC signaling carried by SRB1 other than the RRC reconfiguration complete or non-access stratum (NAS) signaling carried by SRB2.

In some embodiments, that PC5 connection between the remote terminal equipment and a relay terminal equipment is set up may include transmitting a direct communication request or an direct communication response by a V2X (Vehicle to Everything) layer, etc.

In some embodiments, the indication information transmitted by the relay terminal equipment to the remote terminal equipment may include information that the relay terminal equipment enters the RRC_Connected state. In other words, after the remote terminal equipment confirms that the relay terminal equipment has entered the RRC_Connected state, it stops the first timer.

Transmitting the RRC reconfiguration complete message by the remote terminal equipment shall be illustrated below by taking the scenario of adding an indirect path as an example. It shall be understood that the following contents are also applicable to a scenario of changing an indirect path.

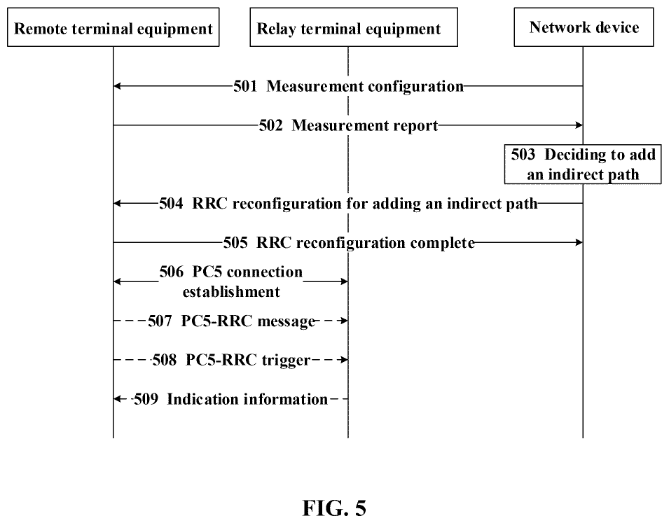

FIG. 5 is a schematic diagram of a process of information exchange of the embodiment of this disclosure. As shown in FIG. 5, the network device transmits a measurement configuration to the remote terminal equipment (501), such as transmitting the measurement configuration via a direct path. The remote terminal equipment transmits a measurement report to the network device (502), such as transmitting the measurement report via a direct path. The network device decides whether to add an indirect path according to the measurement report (503). In a case where the network device decides to add an indirect path, it transmits the RRC reconfiguration message for adding an indirect path to the remote terminal equipment (504), such as transmitting the RRC reconfiguration message via a direct path. In the scenario of changing an indirect path, in 503, the network device decides whether to change an indirect path according to the measurement report of the remote terminal equipment, and the above measurement configuration and/or measurement report may be transmitted via a direct path or an indirect path; in 504, the network device transmits the RRC reconfiguration message for changing an indirect path to the remote terminal equipment, the RRC reconfiguration message being able to be transmitted via a direct path or an indirect path.

The remote terminal equipment may transmit the RRC reconfiguration complete message via a direct path after executing corresponding configurations according to the RRC reconfiguration message (505). The remote terminal equipment establishes PC5 connection with the relay terminal equipment (506). The remote terminal equipment transmits a PC5-RRC message to the relay terminal equipment (507). The remote terminal equipment transmits a PC5-RRC trigger to the relay terminal equipment (508). The relay terminal equipment transmits indication information indicating that the relay terminal equipment has entered the RRC_Connected state to the remote terminal equipment (509).

It should be noted that FIG. 5 only schematically illustrates the embodiment of this disclosure; however, this disclosure is not limited thereto. For example, an order of execution of the steps may be appropriately adjusted, and furthermore, some other steps may be added, or some steps therein may be reduced; for example, 507 and/or 508 and/or 509 is/are optional. And appropriate variants may be made by those skilled in the art according to the above contents, without being limited to what is contained in FIG. 5.

In some embodiments, 507 and 508 may be one step, such as transmitting the PC5-RRC trigger via a PC5-RRC message; however, this disclosure is not limited thereto, and 507 and 508 may also be different steps.

In some embodiments, as shown in FIG. 5, the remote terminal equipment may transmit the RRC reconfiguration complete message after executing corresponding configurations according to the RRC reconfiguration message, that is, 505 may be executed after 504; however, this disclosure is not limited thereto, and the remote terminal equipment may transmit the RRC reconfiguration complete message after establishing PC5 connection with the relay terminal equipment, that is, 505 may be executed after 506. Or, the remote terminal equipment may transmit the RRC reconfiguration complete message after transmitting the PC5-RRC message to the relay terminal equipment, i.e. 505 may be executed after 507. Or, the remote terminal equipment may transmit the RRC reconfiguration complete message after transmitting the PC5-RRC trigger to the relay terminal equipment, i.e. 505 may be executed after 508. Or, the remote terminal equipment may transmit the RRC reconfiguration complete message after receiving the indication information transmitted by the relay terminal equipment, i.e. 505 may be executed after 509.

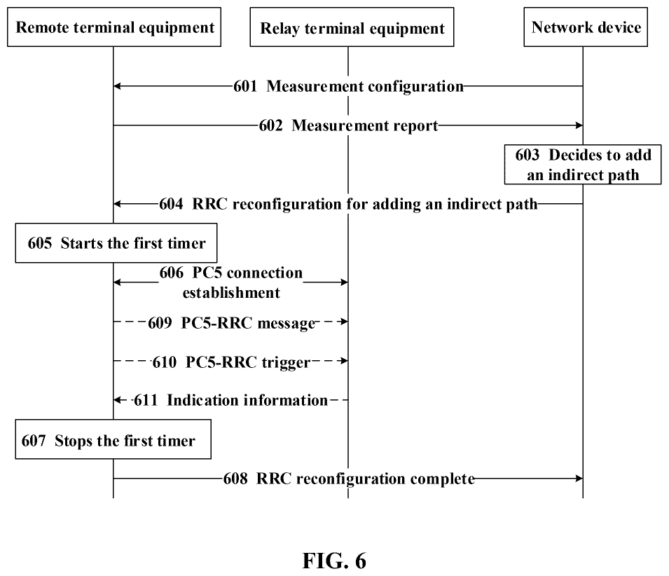

FIG. 6 is another schematic diagram of the process of information exchange of the embodiment of this disclosure. As shown in FIG. 6, the network device transmits measurement configuration to the remote terminal equipment (601). The remote terminal equipment transmits a measurement report to the network device (602). The network device decides whether to add an indirect path according to the measurement report (603). In a case where the network device decides to add an indirect path, it transmits the RRC reconfiguration message for adding an indirect path to the remote terminal equipment (604). In the scenario of changing an indirect path, in 603, the network device decides whether to change an indirect path according to the measurement report of the remote terminal equipment; in 604, the network device transmits the RRC reconfiguration message for changing an indirect path to the remote terminal equipment. Wherein, reference may be made to relevant contents of 501, 502 and 503 in FIG. 5 for transmission modes of the measurement configuration and/or the measurement report and/or the RRC reconfiguration message.

After receiving the RRC reconfiguration message for adding an indirect path, the remote terminal equipment starts the first timer (605). The remote terminal equipment establishes PC5 connection with the relay terminal equipment (606). The remote terminal equipment stops the first timer (607). However, this disclosure is not limited thereto, and as described above, the first timer may also be stopped at other times (first condition). After the first timer is stopped, the remote terminal equipment transmits the RRC reconfiguration complete message to the network device via a direct path (608).

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced; for example, 609 and/or 610 and/or 611, etc., may be added, wherein 609, 610, and 611 may be the same as 507, 508, and 509 in FIG. 5. And appropriate variants may be made by those skilled in the art according to the above contents, without being limited to what is contained in FIG. 6.

In some embodiments, as shown in FIG. 4, the communication method may further include:
403: transmitting the RRC reconfiguration complete message by the remote terminal equipment via an indirect path after the remote terminal equipment establishes PC5 connection with the relay terminal equipment.

For example, in a case where duplication SRB1 or split SRB1 is configured in an indirect path, the remote terminal equipment also transmits the RRC reconfiguration complete message via the indirect path, wherein in the RRC reconfiguration message for adding or changing an indirect path, SRB1 is configured as a duplication or split radio bearer (RB).

FIG. 7 is a further schematic diagram of the process of information exchange of the embodiment of this disclosure. As shown in FIG. 7, the network device transmits measurement configuration to the remote terminal equipment (701). The remote terminal equipment transmits a measurement report to the network device (702). The network device decides whether to add an indirect path according to the measurement report (703). In a case where the network device decides to add an indirect path, it transmits the RRC reconfiguration message for adding an indirect path to the remote terminal equipment (704). In the scenario of changing an indirect path, in 703, the network device decides whether to change an indirect path according to the measurement report of the remote terminal equipment; in 704, the network device transmits the RRC reconfiguration message for changing an indirect path to the remote terminal equipment. Wherein, reference may be made to relevant contents of 501, 502 and 503 in FIG. 5 for transmission modes of the measurement configuration and/or the measurement report and/or the RRC reconfiguration message.

The remote terminal equipment may transmit the RRC reconfiguration complete message via a direct path after executing corresponding configurations according to the RRC reconfiguration message (705). However, this disclosure is not limited thereto, and as described above, the remote terminal equipment may also transmit the RRC reconfiguration complete messages at other times. The remote terminal equipment establishes PC5 connection with the relay terminal equipment (706). The remote terminal equipment transmits the RRC reconfiguration complete message to the relay terminal equipment (707), and the relay terminal equipment transmits the RRC reconfiguration complete message to the network device (708), thereby transmitting the RRC reconfiguration complete message via an indirect path.

It should be noted that FIG. 7 only schematically illustrates the embodiment of this disclosure; however, this disclosure is not limited thereto. For example, an order of execution of the steps may be appropriately adjusted, and furthermore, some other steps may be added, or some steps therein may be reduced, without being limited to what is contained in FIG. 7. For example, the first timer may also be stopped at other times.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

According to the above embodiment, the remote terminal equipment receives a radio resource control reconfiguration message for adding or changing an indirect path transmitted by the network device via a direct path, and transmits a radio resource control reconfiguration complete message to the network device via the direct path, which is helpful for the network device to learn whether the remote terminal equipment successfully performs the configuration in the RRC reconfiguration message or whether successfully adds or changes the indirect path, so that the remote terminal equipment and the network device have consistent understanding of the configuration of the remote terminal equipment, thereby avoiding subsequent configuration conflicts or configuration errors.

### Embodiment of a Second Aspect

The embodiment of this disclosure provides a multi-path communication method, applicable to a remote terminal equipment side, with contents identical to those in the embodiment of the first aspect being not going to be described herein any further. The embodiment of the second aspect may be implemented separately, or, the embodiment of the second aspect may be implemented in combination with the embodiment of the first aspect.

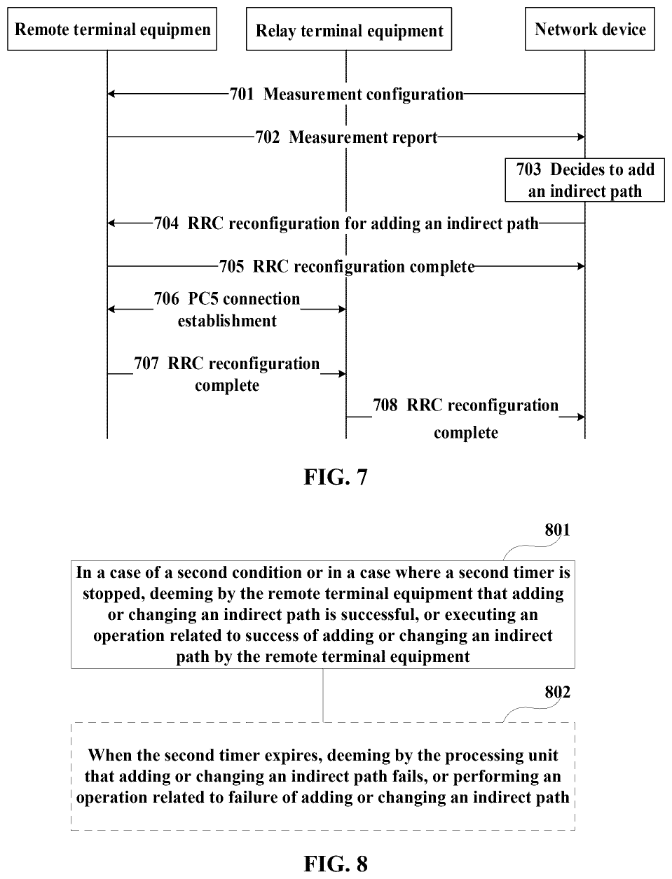

FIG. 8 is a schematic diagram of the multi-path communication method of the embodiment of this disclosure. As shown in FIG. 8, the method includes:
801: in a case of a second condition or in a case where a second timer is stopped, deeming by the remote terminal equipment that adding or changing an indirect path is successful, or executing an operation related to success of adding or changing an indirect path by the remote terminal equipment.

It should be noted that FIG. 8 only schematically illustrates the embodiment of this disclosure; however, this disclosure is not limited thereto. For example, an order of execution of the steps may be appropriately adjusted, and furthermore, some other steps may be added, or some steps therein may be reduced, without being limited to what is contained in FIG. 8.

According to the above embodiment, in the case of the second condition or in a case where the second timer is stopped, the remote terminal equipment deems that the adding or changing an indirect path is successful, or executes the operation related to success of adding or changing an indirect path. Thus, the remote terminal equipment is able to determine whether the operation of adding or changing an indirect path is successful according to the second condition or the second timer, or determine whether the operation related to success of adding or changing an indirect path may be executed, thereby avoiding inappropriate operations by the remote terminal equipment.

In some embodiments, the operation related to success of adding or changing an indirect path may include: an RRC layer of the remote terminal equipment submits an RRC reconfiguration complete message to a lower layer for transmission, or transmits uplink data via the indirect path.

In some embodiments, the second timer may be started when the remote terminal equipment receives the RRC reconfiguration message for adding or changing an indirect path; however, this disclosure is not limited thereto, and the second timer may also be started at other times.

In some embodiments, the second timer may be stopped under the second condition, the second condition including at least one of the following: the radio resource control reconfiguration complete message is successfully transmitted; the remote terminal equipment transmits a PC5-RRC message to the relay terminal equipment; the remote terminal equipment transmits a PC5-S message to the relay terminal equipment; the remote terminal equipment transmits data of a radio bearer via the relay terminal equipment; a PC5-RRC message and/or a PC5-S message is/are successfully transmitted to the relay terminal equipment; the remote terminal equipment sets up PC5 connection with the relay terminal equipment; or the remote terminal equipment receives indication information transmitted by the relay terminal equipment.

In some embodiments, the PC5-RRC message transmitted by the remote terminal equipment to the relay terminal equipment may include at least one of the following: a remote UE information sidelink (RemoteUEInformationSidelink), an RRC reconfiguration sidelink (RRCReconfigurationSidelink), an RRC reconfiguration complete sidelink (RRCReconfigurationCompleteSidelink), a UE assistance information sidelink (UEAssistanceInformationSidelink), or a new PC5-RRC message.

In some embodiments, the PC5-S message transmitted by the remote terminal equipment to the relay terminal equipment may include at least one of the following: a discovery-related message; or a direct communication request/response message.

In some embodiments, the discovery-related message may include at least one of the following: a discovery solicitation, or a discovery response.

In some embodiments, the data of the radio bearer may be data of a data radio bearer (DRB) or signaling of a signaling radio bearer (SRB), such as RRC signaling carried by SRB1 other than the RRC reconfiguration complete or non-access stratum (NAS) signaling carried by SRB2.

In some embodiments, that an RRC reconfiguration complete message and/or a PC5-RRC message and/or a PC5-S message is/are successfully transmitted to the relay terminal equipment may include that the remote terminal equipment receives feedback information from the relay terminal equipment regarding the RRC reconfiguration complete message and/or the PC5-RRC message and/or the PC5-S message, such as acknowledgement from the PC5-RLC layer.

In some embodiments, that PC5 connection between the remote terminal equipment and a relay terminal equipment is set up may include transmitting a direct communication request or a direct communication response by a V2X (Vehicle to Everything) layer, etc.

In some embodiments, the indication information transmitted by the relay terminal equipment to the remote terminal equipment may include information that the relay terminal equipment enters the RRC_Connected state. In other words, after the remote terminal equipment confirms that the relay terminal equipment has entered the RRC_Connected state, it stops the second timer.

In some embodiments, as shown in FIG. 8, the communication method may further include:
802: when the second timer expires, deeming by the processing unit that adding or changing an indirect path fails, or performing an operation related to failure of adding or changing an indirect path.

In some embodiments, the operation related to failure of adding or changing an indirect path may include: transmitting failure information to the network device or initiating a radio resource control reestablishment procedure, wherein reference may be made to contents of an embodiment of a third aspect below for contents of the failure information transmitted to the network device, and reference may be made to relevant techniques for contents of initiating the RRC reestablishment procedure.

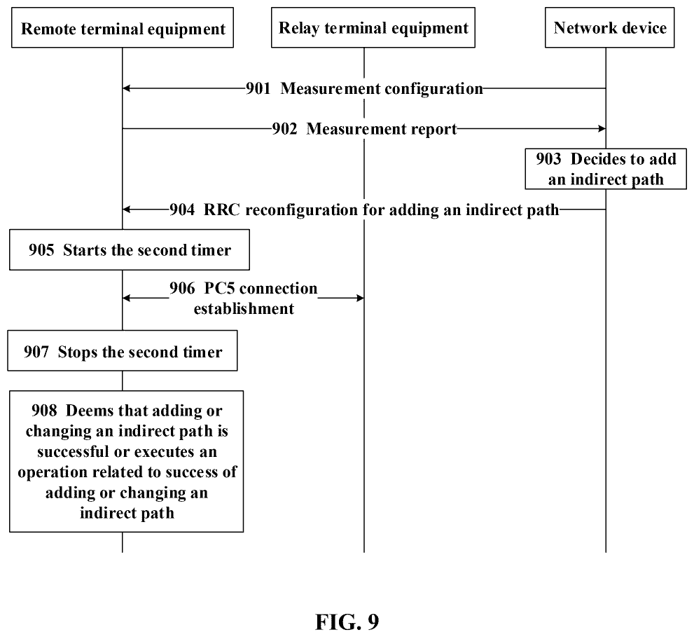

FIG. 9 is still another schematic diagram of the process of information exchange of the embodiment of this disclosure. As shown in FIG. 9, the network device transmits measurement configuration to the remote terminal equipment (901). The remote terminal equipment transmits a measurement report to the network device (902). The network device decides whether to add an indirect path according to the measurement report (903). In a case where the network device decides to add an indirect path, it transmits the RRC reconfiguration message for adding an indirect path to the remote terminal equipment (904). In the scenario of changing an indirect path, in 903, the network device decides whether to change an indirect path according to the measurement report of the remote terminal equipment; in 904, the network device transmits the RRC reconfiguration message for changing an indirect path to the remote terminal equipment. Wherein, reference may be made to relevant contents of 501, 502 and 503 in FIG. 5 for transmission modes of the measurement configuration and/or the measurement report and/or the RRC reconfiguration message.

After receiving the RRC reconfiguration message for adding an indirect path, the remote terminal equipment starts the second timer (905). The remote terminal equipment establishes PC5 connection with the relay terminal equipment (906). The remote terminal equipment stops the second timer (907). However, this disclosure is not limited thereto, and as described above, the second timer may also be stopped at other times (second condition). In the case where the second timer is stopped, the remote terminal equipment deems that adding or changing an indirect path is successful or executes the operation related to success of adding or changing an indirect path (908).

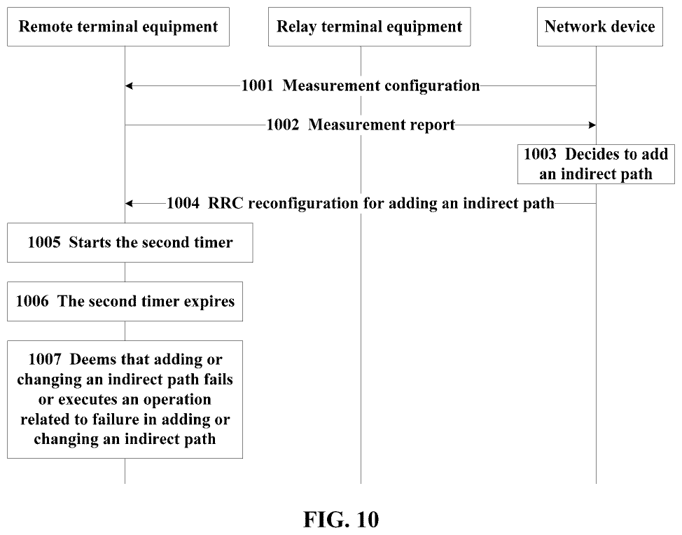

FIG. 10 is yet another schematic diagram of the process of information exchange of the embodiment of this disclosure. As shown in FIG. 10, 1001-1005 are identical to 901-905 in FIG. 9. In a case where the second condition is not satisfied, the second timer expires (1006). In the case where the second timer expires, the remote terminal equipment deems that adding or changing an indirect path fails or executes an operation related to failure of adding or changing an indirect path (1007).

It should be noted that FIGS. 9 and 10 only schematically illustrate the embodiment of this disclosure; however, this disclosure is not limited thereto. For example, an order of execution of the steps may be appropriately adjusted, and furthermore, some other steps may be added, or some steps therein may be reduced, without being limited to what is contained in FIGS. 9 and 10.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that in the case of the second condition or in a case where the second timer is stopped, the remote terminal equipment deems that adding or changing an indirect path is successful or executes an operation related to success of adding or changing an indirect path. Thus, the remote terminal equipment is able to determine whether the operation of adding or changing an indirect path is successful according to the second condition or the second timer, or determine whether the operation of success of adding or changing an indirect path may be executed, thereby avoiding inappropriate operations by the remote terminal equipment.

### Embodiment of a Third Aspect

The embodiment of this disclosure provides a multi-path communication method, applicable to a remote terminal equipment side, with contents identical to those in the embodiments of the first and second aspects being not going to be described herein any further. The embodiment of the third aspect may be implemented separately, or, the embodiment of the third aspect may be implemented in combination with the embodiment(s) of the first aspect and/or the second aspect.

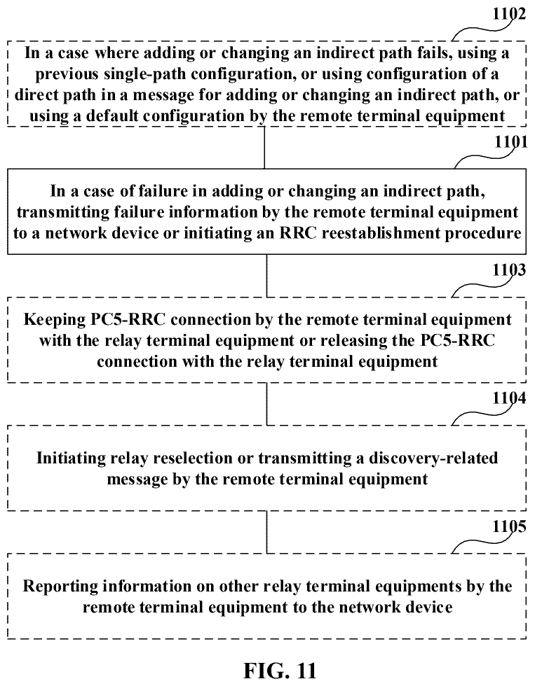

FIG. 11 is a schematic diagram of the multi-path communication method of the embodiment of this disclosure. As shown in FIG. 11, the method includes:
1101: in a case of failure in adding or changing an indirect path, transmitting failure information by the remote terminal equipment to a network device or initiating an RRC reestablishment procedure.

It should be noted that FIG. 11 only schematically illustrates the embodiment of this disclosure; however, this disclosure is not limited thereto. For example, an order of execution of the steps may be appropriately adjusted, and furthermore, some other steps may be added, or some steps therein may be reduced, without being limited to what is contained in FIG. 11.

According to the above embodiment, in the case where adding or changing an indirect path fails, the remote terminal equipment transmits failure information to the network device or initiates an RRC reestablishment procedure, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

In some embodiments, the failure in adding or changing an indirect path may include: a relay terminal equipment fails in entering a connected state; radio resource control connection of a relay terminal equipment is rejected; a relay terminal equipment changes a serving cell or a serving base station; cell selection occurs in a relay terminal equipment; cell reselection occurs in a relay terminal equipment; handover occurs in a relay terminal equipment; a third timer expires; PC5 connection setup fails; or a PC5 radio link fails.

In some embodiments, in the scenario of adding or changing an indirect path, the added relay terminal equipment may be in the RRC_Idle or RRC_Inactive state. The relay terminal equipment needs to enter the RRC_Connected state so as to provide relay services to the remote terminal equipment. In a case where the relay terminal equipment fails in entering a connected state or the RRC connection of the relay terminal equipment is rejected, it may result in failure in adding or changing an indirect path.

In some embodiments, between the time when the remote terminal equipment receives the measurement configuration transmitted by the network device and the time when it establishes PC5 connection with the relay terminal equipment, the relay terminal equipment may change a serving cell or a serving base station. As a serving cell (or a serving base station) to which the remote terminal equipment is connected via a direct path needs to be identical to a serving cell (or a serving base station) to which the remote terminal equipment is connected via the relay terminal equipment, in a case where the relay terminal equipment changes a serving cell or a serving base station, the relay terminal equipment performs cell selection and the relay terminal equipment performs cell reselection or the relay terminal equipment handovers, it may be resulted in that adding or changing an indirect path fails.

In some embodiments, in a case where establishment of the PC5 connection between the remote terminal equipment and the relay terminal equipment fails, or establishment of the PC5 connection is successful but a PC5 radio link fails, it may be resulted in that adding or changing an indirect path fails.

In some embodiments, the third timer is stopped under a third condition, the third condition including at least one of the following: a radio resource control reconfiguration complete message is successfully transmitted; the remote terminal equipment transmits a PC5-RRC message to the relay terminal equipment; the remote terminal equipment transmits a PC5-S message to the relay terminal equipment; the remote terminal equipment transmits data of a radio bearer via the relay terminal equipment; a PC5-RRC message and/or a PC5-S message is/are successfully transmitted to the relay terminal equipment; the remote terminal equipment sets up PC5 connection with the relay terminal equipment; or the remote terminal equipment receives indication information transmitted by the relay terminal equipment. The third condition may be identical or similar to the second condition in the embodiment of the second aspect, contents of which being incorporated herein, which shall not be described herein any further.

In some embodiments, the remote terminal equipment may transmit the failure information via a direct path; however, this disclosure is not limited thereto, and the failure information may also be transmitted via an indirect path. For example, in the case where changing an indirect path fails, the failure information may be transmitted via an original indirect path.

In some embodiments, that the remote terminal equipment initiates an RRC reestablishment procedure includes that the remote terminal equipment performs cell selection and/or relay selection, and after finding a suitable cell and/or a suitable relay terminal equipment, transmits an RRC reestablishment request message in the cell or via the relay terminal equipment.

In some embodiments, in the case where adding or changing an indirect path fails, the remote terminal may initiate the RRC reestablishment procedure if SRB1 or split SRB1 or duplicate SRB1 is not configured in the direct path. For example, in the RRC reconfiguration message for adding or changing an indirect path, only SRB1 is configured in the indirect path, that is, SRB1 or split SRB1 or duplicate SRB1 is not configured in the direct path.

In some embodiments, the failure information may be transmitted at various times. For example, the failure information may be transmitted after the remote terminal equipment receives a notification transmitted by the relay terminal equipment.

In some embodiments, the notification may include at least one of the following: an RRC connection setup or recovery procedure of the relay terminal equipment fails or is rejected; cell reselection or handover occurs in the relay terminal equipment; a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

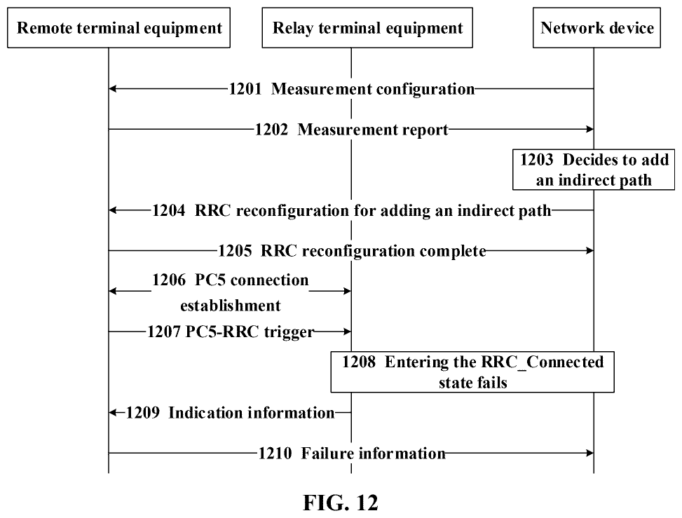

FIG. 12 is still another schematic diagram of the process of information exchange of the embodiment of this disclosure. As shown in FIG. 12, the network device transmits measurement configuration to the remote terminal equipment (1201). The remote terminal equipment transmits a measurement report to the network device (1202). The network device decides whether to add an indirect path according to the measurement report (1203). In a case where the network device decides to add an indirect path, it transmits the RRC reconfiguration message for adding an indirect path to the remote terminal equipment (1204). In the scenario of changing an indirect path, in 1203, the network device decides whether to change an indirect path according to the measurement report of the remote terminal equipment; in 1204, the network device transmits the RRC reconfiguration message for changing an indirect path to the remote terminal equipment. Wherein, reference may be made to relevant contents of 501, 502 and 503 in FIG. 5 for transmission modes of the measurement configuration and/or the measurement report and/or the RRC reconfiguration message.

The remote terminal equipment transmits the RRC reconfiguration complete message to the network device via a direct path (1205). However, this disclosure is not limited thereto, and as described above, the remote terminal equipment may also transmit the RRC reconfiguration complete message to the network device via a direct path at other times. The remote terminal equipment establishes PC5 connection with the relay terminal equipment (1206). The remote terminal equipment transmits the PC5-RRC trigger to the relay terminal equipment (1207), so as to enable the relay terminal equipment to enter the RRC_Connected state. In a case where the relay terminal equipment fails in entering the RRC_Connected state (1208), the relay terminal equipment transmits a sidelink indication message to the remote terminal equipment (1209). The remote terminal equipment transmits the failure information to the network device (1210).

In some embodiments, the failure information may be included in an RRC message or an indication of a low layer.

In some embodiments, the RRC message may include at least one of the following: a sidelink UE information message; a secondary cell group failure information (SCG failure information) message; or a new RRC message.

In some embodiments, the indication of a low layer may include at least one of the following: a PDCP control PDU, an RLC control PDU, or an MAC CE.

In some embodiments, the failure information may include a failure type and/or a failure cause, thereby providing more useful information to the network device.

In some embodiments, the failure type and/or the failure cause may include at least one of the following: the relay terminal equipment fails in entering a connected state; radio resource control connection of the relay terminal equipment is rejected; the relay terminal equipment changes a serving cell or a serving base station; cell selection occurs in a relay terminal equipment; cell reselection occurs in a relay terminal equipment; handover occurs in a relay terminal equipment; a third timer expires; PC5 connection setup fails; or a PC5 resource link fails.

In some embodiments, as shown in FIG. 11, the method may further include:
1102: in a case where adding or changing an indirect path fails, using a previous single-path configuration, or using configuration of a direct path in a message for adding or changing an indirect path, or using a default configuration.

For example, the remote terminal equipment may use a configuration of a direct path before receiving the RRC reconfiguration message of adding or changing an indirect path (also referred to as an RRC reconfiguration message for adding or changing an indirect path), or may use a configuration of a direct path included in the RRC reconfiguration message of adding or changing an indirect path (also referred to as an RRC reconfiguration message for adding or changing an indirect path, or an indirect path addition or change message), or may use a predefined default configuration, wherein the configuration may include a configuration of an access layer, for example, the configuration may include at least one of the following: configuration of a special cell (SpCell), a configuration of a secondary cell (SCell), a radio bearer configuration, a security configuration, an RLC bearer configuration, a logical channel configuration, a configuration of a radio link failure (RLF) timer, etc.

In some embodiments, in case of success of adding or changing an indirect path, the remote terminal equipment uses the configuration in the RRC reconfiguration message for adding or changing an indirect path.

In some embodiments, 1102 may be executed before 1101. For example, in the case where adding or changing an indirect path fails, the remote terminal equipment may first use a previous configuration of a single path or use a configuration of a direct path in the message for adding or changing an indirect path or use a default configuration (1102), and then transmit the failure information to the network device or initiate an RRC reestablishment procedure (1101). For example, in 1101, the configuration in 1102 may be used to transmit the failure information. However, this disclosure is not limited thereto, and 1101 and 1102 may also be executed in other orders, for example, 1101 and 1102 are executed simultaneously, or 1102 is executed after 1101.

In some embodiments, as shown in FIG. 11, the method may further include:
1103: keeping PC5-RRC connection by the remote terminal equipment with the relay terminal equipment or releasing the PC5-RRC connection with the relay terminal equipment; and/or,
1104: initiating relay reselection or transmitting a discovery-related message by the remote terminal equipment; and/or,
1105: reporting information on other relay terminal equipments by the remote terminal equipment to the network device.

In some embodiments, the information on other relay terminal equipments may include: identifiers of the other relay terminal equipments and/or measurement results of the other relay terminal equipments, such as SL-RSRP (sidelink reference signal received power) and SD-RSRP (sidelink discovery reference signal received power).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case where adding or changing an indirect path fails, the remote terminal equipment transmits failure information to the network device or initiates an RRC reestablishment procedure, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

### Embodiment of a Fourth Aspect

The embodiment of this disclosure provides a multi-path communication method, applicable to a network device side, with contents identical to those in the embodiment of the first aspect being not going to be described herein any further.

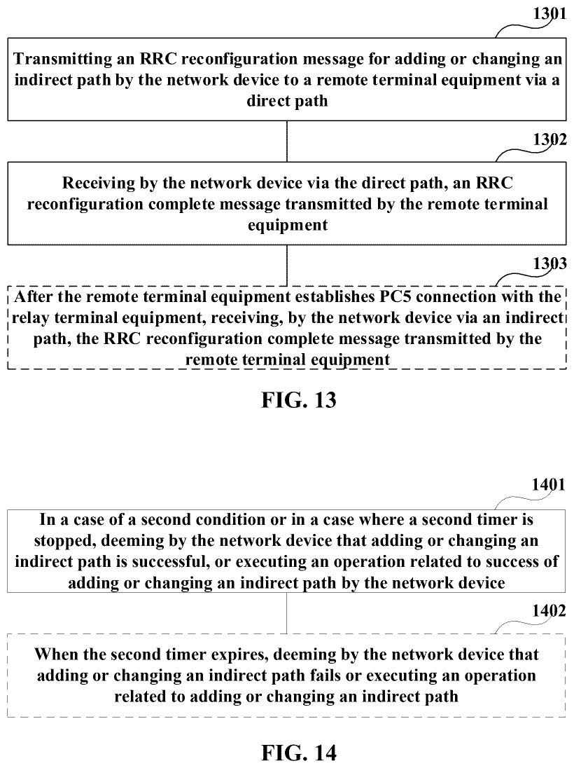

FIG. 13 is a schematic diagram of the multi-path communication method of the embodiment of this disclosure. As shown in FIG. 13, the method includes:
1301: transmitting an RRC reconfiguration message for adding or changing an indirect path by the network device to a remote terminal equipment via a direct path; and
1302: receiving by the network device via the direct path, an RRC reconfiguration complete message transmitted by the remote terminal equipment.

It should be noted that FIG. 13 only schematically illustrates the embodiment of this disclosure; however, this disclosure is not limited thereto. For example, an order of execution of the steps may be appropriately adjusted, and furthermore, some other steps may be added, or some steps therein may be reduced, without being limited to what is contained in FIG. 13.

In some embodiments, the RRC reconfiguration complete message is transmitted in at least one of the following times:
after the remote terminal equipment performs corresponding configuration according to the RRC reconfiguration message;
after the remote terminal equipment establishes PC5 connection with the relay terminal equipment;
after the remote terminal equipment transmits a PC5-RRC message to the relay terminal equipment;
after the remote terminal equipment transmits a PC5-RRC trigger to the relay terminal equipment;
after the remote terminal equipment receives indication information transmitted by the relay terminal equipment; or
after a first timer used for a procedure of adding or changing an indirect path is stopped.

In some embodiments, the PC5-RRC message includes at least one of the following:
RemoteUEInformationSidelink;
RRCReconfigurationSidelink;
RRCReconfigurationCompleteSidelink;
UEAssistanceInformationSidelink; or
a new PC5-RRC message.

In some embodiments, the PC5-RRC trigger is used to cause the relay terminal equipment to enter an RRC_Connected state.

In some embodiments, the indication information includes information that the relay terminal equipment enters the RRC_Connected state.

In some embodiments, the first timer is started when the remote terminal equipment receives the RRC reconfiguration message for adding or changing an indirect path.

In some embodiments, the first timer is stopped under a first condition, the first condition including at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment set up PC5 connection with the relay terminal equipment; or
the remote terminal equipment receives indication information transmitted by the relay terminal equipment.

In some embodiments, the PC5-S message includes at least one of the following:
a discovery-related message; or
a direct communication request/response message.

In some embodiments, the discovery-related message may include at least one of the following:
a discovery solicitation, or
a discovery response.

In some embodiments, as shown in FIG. 13, the method further includes:
1303: after the remote terminal equipment establishes PC5 connection with the relay terminal equipment, receiving, by the network device via an indirect path, the RRC reconfiguration complete message transmitted by the remote terminal equipment.

For example, in a case where duplication SRB1 or split SRB1 is configured in an indirect path, the network device receives via the indirect path the RRC reconfiguration complete message, wherein in the RRC reconfiguration message for adding or changing an indirect path, SRB1 is configured as a duplication or split radio bearer (RB).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, the network device transmits the RRC reconfiguration message for adding or changing an indirect path to the remote terminal equipment via a direct path, and receives the RRC reconfiguration complete message transmitted by the remote terminal equipment via the direct path, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

### Embodiment of a Fifth Aspect

The embodiment of this disclosure provides a multi-path communication method, applicable to a network device side, with contents identical to those in the embodiment of the second aspect being not going to be described herein any further. The embodiment of the fifth aspect may be implemented separately, or, the embodiment of the fifth aspect may be implemented in combination with the embodiment of the fourth aspect.

FIG. 14 is a schematic diagram of the multi-path communication method of the embodiment of this disclosure. As shown in FIG. 14, the method includes:
1401: in a case of a second condition or in a case where a second timer is stopped, deeming by the network device that adding or changing an indirect path is successful, or executing an operation related to success of adding or changing an indirect path by the network device.

It should be noted that FIG. 14 only schematically illustrates the embodiment of this disclosure; however, this disclosure is not limited thereto. For example, an order of execution of the steps may be appropriately adjusted, and furthermore, some other steps may be added, or some steps therein may be reduced, without being limited to what is contained in FIG. 14.

In some embodiments, the operation related to success of adding or changing an indirect path includes:
the network device receives an RRC reconfiguration complete message or receives uplink data via the indirect path.

In some embodiments, the second timer is stopped under the second condition, the second condition including at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

In some embodiments, the second timer is started when the remote terminal equipment receives the RRC message for adding or changing an indirect path.

In some embodiments, as shown in FIG. 14, the method may further include:
1402: when the second timer expires, deeming by the network device that adding or changing an indirect path fails or executing an operation related to adding or changing an indirect path.

In some embodiments, the operation related to adding or changing an indirect path includes:
receiving failure information transmitted by the remote terminal equipment or initiating an RRC reestablishment procedure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in the case of the second condition or in a case where the second timer is stopped, the network device deems that adding or changing an indirect path is successful, or the network device executes the operation related to success of adding or changing an indirect path. Therefore, the network device may determine whether the operation of adding or changing an indirect path is successful according to the second condition or the second timer, or determine whether the operation related to success of adding or changing an indirect path may be executed, thereby avoiding inappropriate operations by the network device.

### Embodiment of a Sixth Aspect

The embodiment of this disclosure provides a multi-path communication method, applicable to a network device side, with contents identical to those in the embodiments of the third aspect being not going to be described herein any further. The embodiment of the sixth aspect may be implemented separately, or, the embodiment of the sixth aspect may be implemented in combination with the embodiment(s) of the fourth aspect and/or the fifth aspect.

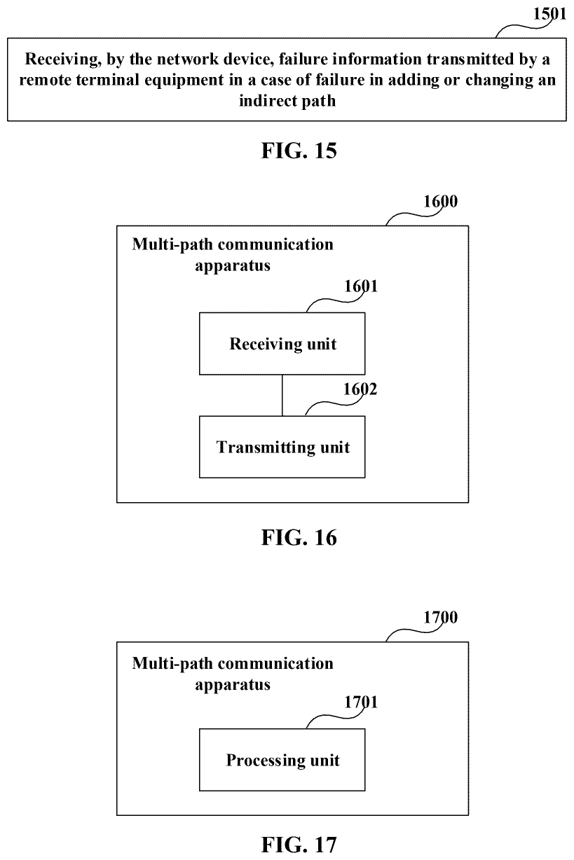

FIG. 15 is a schematic diagram of the multi-path communication method of the embodiment of this disclosure. As shown in FIG. 15, the method includes:
1501: receiving, by the network device, failure information transmitted by a remote terminal equipment in a case of failure in adding or changing an indirect path.

It should be noted that FIG. 15 only schematically illustrates the embodiment of this disclosure; however, this disclosure is not limited thereto. For example, an order of execution of the steps may be appropriately adjusted, and furthermore, some other steps may be added, or some steps therein may be reduced, without being limited to what is contained in FIG. 15.

In some embodiments, the failure in adding or changing an indirect path includes:
a relay terminal equipment fails in entering a connected state;
radio resource control connection of a relay terminal equipment is rejected;
a relay terminal equipment changes a serving cell or a serving base station;
cell selection occurs in a relay terminal equipment; cell reselection occurs in a relay terminal equipment;
handover occurs in a relay terminal equipment;
a third timer expires;
PC5 connection setup fails; or
a PC5 radio link fails.

In some embodiments, the third timer is stopped under a third condition, the third condition including at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

In some embodiments, the network device may receive the failure information via a direct path.

In some embodiments, the failure information is transmitted after the remote terminal equipment receives a notification transmitted by the relay terminal equipment.

In some embodiments, the notification includes at least one of the following:
an RRC connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

In some embodiments, the failure information is included in an RRC message or an indication of a lower layer.

In some embodiments, the RRC message includes at least one of the following:
a sidelink UE information message;
an SCG failure information message; or
a new RRC message.

In some embodiments, the indication of a low layer may include at least one of the following:
a PDCP control PDU;
an RLC control PDU, or
an MAC CE.

In some embodiments, the failure information includes a failure type and/or a failure cause.

In some embodiments, the failure type and/or the failure cause include(s) at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment; handover occurs in a relay terminal equipment;
a third timer expires;
PC5 connection setup fails; or
a PC5 resource link fails.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

According to the above embodiment, in a case of failure in adding or changing an indirect path, the network device receives the failure information transmitted by the remote terminal equipment, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

### Embodiment of a Seventh Aspect

The embodiment of this disclosure provides a multi-path communication apparatus. The apparatus may be, for example, a remote terminal equipment, or may be one or some components or assemblies configured in the remote terminal equipment, with contents identical to those in the embodiment of the first aspect being not going to be described herein any further.

FIG. 16 is a schematic diagram of the multi-path communication apparatus of the embodiment of this disclosure. As shown in FIG. 16, the multi-path communication apparatus 1600 includes:
a receiving unit 1601 configured to receive an RRC reconfiguration message for adding or changing an indirect path transmitted by a network device via a direct path; and
a transmitting unit 1602 configured to transmit an RRC reconfiguration complete message to the network device via the direct path.

In some embodiments, the RRC reconfiguration complete message is transmitted at one of the following times:
after the remote terminal equipment executes corresponding configurations according to the radio resource control reconfiguration message;
after PC5 connection between the remote terminal equipment and a relay terminal equipment is set up;
after the remote terminal equipment transmits a PC5-RRC message to a relay terminal equipment;
after the remote terminal equipment transmits PC5-RRC trigger to a relay terminal equipment;
after the remote terminal equipment receives indication information transmitted by a relay terminal equipment; or
after a first timer used for a procedure of adding or changing an indirect path is stopped.

In some embodiments, the PC5-RRC message includes at least one of the following:
RemoteUEInformationSidelink;
RRCReconfigurationSidelink;
RRCReconfigurationCompleteSidelink;
UEAssistanceInformationSidelink; or
a new PC5 RRC message;

In some embodiments, the PC5-RRC trigger is used to cause the relay terminal equipment to enter an RRC_Connected state;
In some embodiments, the indication information includes information that the relay terminal equipment enters a radio resource control connected state.

In some embodiments, the first timer is started when the remote terminal equipment receives the RRC reconfiguration message for adding or changing an indirect path;

In some embodiments, the first timer is stopped under a first condition, the first condition including at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment set up PC5 connection with the relay terminal equipment; or
the remote terminal equipment receives indication information transmitted by the relay terminal equipment.

In some embodiments, the PC5-S message includes at least one of the following:
a discovery-related message; or
a direct communication request/response message.

In some embodiments, after the remote terminal equipment sets up the PC5 connection with the relay terminal equipment, the transmitting unit 1602 further transmits the radio resource control reconfiguration complete message via an indirect path.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path communication apparatus 1600 may further include other components or modules, and reference may be made to related techniques for particulars of these components or modules.

Furthermore, for the sake of simplicity, connection relationships between the components or modules or signal profiles thereof are only illustrated in FIG. 16. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in the case of the second condition or in a case where the second timer is stopped, the remote terminal equipment deems that the adding or changing an indirect path is successful, or executes the operation related to success of adding or changing an indirect path. Thus, the remote terminal equipment is able to determine whether the operation of adding or changing an indirect path is successful according to the second condition or the second timer, or determine whether the operation related to success of adding or changing an indirect path may be executed, thereby avoiding inappropriate operations by the remote terminal equipment.

### Embodiment of an Eighth Aspect

The embodiment of this disclosure provides a multi-path communication apparatus. The apparatus may be, for example, a remote terminal equipment, or may be one or some components or assemblies configured in the remote terminal equipment, with contents identical to those in the embodiment of the second aspect being not going to be described herein any further.

FIG. 17 is a schematic diagram of the multi-path communication apparatus of the embodiment of this disclosure. As shown in FIG. 17, the multi-path communication apparatus 1700 includes:
a processing unit 1701 configured to, in a case of a second condition or in a case where a second timer is stopped, deem that adding or changing an indirect path is successful, or execute an operation related to success of adding or changing an indirect path.

In some embodiments, the operation related to success of adding or changing an indirect path includes:
a radio resource control layer of the remote terminal equipment submits a radio resource control reconfiguration complete message to a lower layer for transmission, or transmits uplink data via the indirect path.

In some embodiments, the second timer is stopped under the second condition, the second condition including at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

In some embodiments, the second timer is started when the remote terminal equipment receives a radio resource control message for adding or changing an indirect path.

In some embodiments, when the second timer expires, the processing unit deems that adding or changing an indirect path fails, or performs an operation related to failure of adding or changing an indirect path.

In some embodiments, the operation related to failure of adding or changing an indirect path includes:
transmitting failure information to a network device or initiating a radio resource control reestablishment procedure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path communication apparatus 1700 may further include other components or modules, and reference may be made to related techniques for particulars of these components or modules.

Furthermore, for the sake of simplicity, connection relationships between the components or modules or signal profiles thereof are only illustrated in FIG. 17. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in the case of the second condition or in a case where the second timer is stopped, the remote terminal equipment deems that the adding or changing an indirect path is successful, or executes the operation related to success of adding or changing an indirect path. Thus, the remote terminal equipment is able to determine whether the operation of adding or changing an indirect path is successful according to the second condition or the second timer, or determine whether the operation related to success of adding or changing an indirect path may be executed, thereby avoiding inappropriate operations by the remote terminal equipment.

### Embodiment of a Ninth Aspect

The embodiment of this disclosure provides a multi-path communication apparatus. The apparatus may be, for example, a remote terminal equipment, or may be one or some components or assemblies configured in the remote terminal equipment, with contents identical to those in the embodiment of the second aspect being not going to be described herein any further.

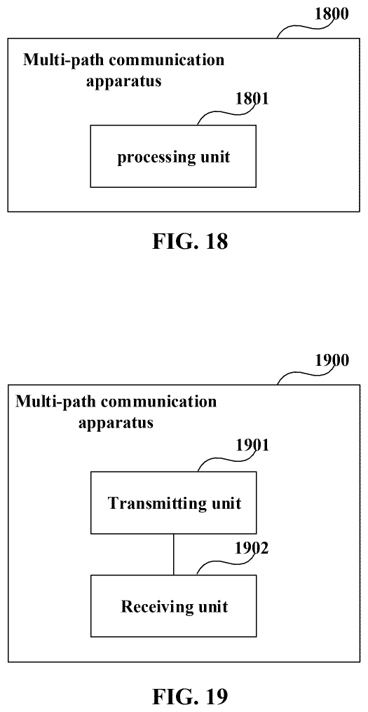

FIG. 18 is a schematic diagram of the multi-path communication apparatus of the embodiment of this disclosure. As shown in FIG. 18, the multi-path communication apparatus 1800 includes:
a processing unit 1801 configured to, in a case of failure in adding or changing an indirect path, transmit failure information to a network device or initiate a radio resource control reestablishment procedure.

In some embodiments, the failure in adding or changing an indirect path includes:
a relay terminal equipment fails in entering a connected state;
radio resource control connection of a relay terminal equipment is rejected;
a relay terminal equipment changes a serving cell or a serving base station;
cell selection occurs in a relay terminal equipment;
cell reselection occurs in a relay terminal equipment;
handover occurs in a relay terminal equipment;
a third timer expires;
PC5 connection setup fails; or
a PC5 radio link fails.

In some embodiments, the third timer is stopped under a third condition, the third condition including at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

In some embodiments, the remote terminal equipment may transmit the failure information via the direct path.

In some embodiments, the failure information is transmitted after the remote terminal equipment receives a notification transmitted by the relay terminal equipment.

In some embodiments, the notification includes at least one of the following:
a radio resource control connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

In some embodiments, the failure information is included in an RRC message or an indication of a low layer.

In some embodiments, the RRC message includes at least one of the following:
a sidelink UE information message;
an SCG failure information message; or
a new radio resource control message;
In some embodiments, the indication of a low layer includes at least one of the following:
a PDCP control PDU);
an RLC control PDU; or
an MAC CE.

In some embodiments, the failure information includes a failure type and/or a failure cause.

In some embodiments, the failure type and/or the failure cause include(s) at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment;
handover occurs in a relay terminal equipment;
a third timer expires;
PC5 connection setup fails; or
a PC5 resource link fails.

In some embodiments, in a case where adding or changing an indirect path fails, the processing unit 1801 uses a previous single-path configuration, or uses configuration of a direct path in a message for adding or changing an indirect path, or uses a default configuration.

In some embodiments, the processing unit 1801 keeps PC5-RRC connection with the relay terminal equipment or releases the PC5-RRC connection with the relay terminal equipment; and/or,
the processing unit 1801 initiates relay reselection or transmits a discovery-related message; and/or,
the processing unit 1801 reports information on other relay terminal equipments to the network device.

In some embodiments, the information on other relay terminal equipments includes:
identifiers of the other relay terminal equipments and/or measurement results of the other relay terminal equipments.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path communication apparatus 1800 may further include other components or modules, and reference may be made to related techniques for particulars of these components or modules.

Furthermore, for the sake of simplicity, connection relationships between the components or modules or signal profiles thereof are only illustrated in FIG. 18. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in the case where adding or changing an indirect path fails, the remote terminal equipment transmits failure information to the network device or initiates an RRC reestablishment procedure, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

### Embodiment of a Tenth Aspect

The embodiment of this disclosure provides a multi-path communication apparatus. The apparatus may be, for example, a network device, or may be one or some components or assemblies configured in the network device, with contents identical to those in the embodiment of the fourth aspect being not going to be described herein any further.

FIG. 19 is a schematic diagram of the multi-path communication apparatus of the embodiment of this disclosure. As shown in FIG. 19, the multi-path communication apparatus 1900 includes:
a transmitting unit 1901 configured to transmit an RRC reconfiguration message for adding or changing an indirect path to a remote terminal equipment via a direct path; and
a receiving unit 1902 configured to receive via the direct path an RRC reconfiguration complete message transmitted by the remote terminal equipment.

In some embodiments, the RRC reconfiguration complete message is transmitted in at least one of the following times:
after the remote terminal equipment performs corresponding configuration according to the RRC reconfiguration message;
after the remote terminal equipment establishes PC5 connection with the relay terminal equipment;
after the remote terminal equipment transmits a PC5-RRC message to the relay terminal equipment;
after the remote terminal equipment transmits a PC5-RRC trigger to the relay terminal equipment;
after the remote terminal equipment receives indication information transmitted by the relay terminal equipment; or
after a first timer used for a procedure of adding or changing an indirect path is stopped.

In some embodiments, the PC5-RRC message includes at least one of the following:
RemoteUEInformationSidelink;
RRCReconfigurationSidelink;
RRCReconfigurationCompleteSidelink;
UEAssistanceInformationSidelink; or
a new PC5-RRC message.

In some embodiments, the PC5-RRC trigger is used to cause the relay terminal equipment to enter an RRC_Connected state.

In some embodiments, the indication information includes information that the relay terminal equipment enters the RRC_Connected state.

In some embodiments, the first timer is started when the remote terminal equipment receives the RRC reconfiguration message for adding or changing an indirect path.

In some embodiments, the first timer is stopped under a first condition, the first condition including at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment set up PC5 connection with the relay terminal equipment; or
the remote terminal equipment receives indication information transmitted by the relay terminal equipment.

In some embodiments, the PC5-S message includes at least one of the following:
a discovery-related message; or
a direct communication request/response message.

In some embodiments, the discovery-related message includes at least one of the following:
a discovery solicitation, or
a discovery response.

In some embodiments, after the remote terminal equipment establishes PC5 connection with the relay terminal equipment, the receiving unit 1902 further receives via an indirect path the RRC reconfiguration complete message transmitted by the remote terminal equipment.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path communication apparatus 1900 may further include other components or modules, and reference may be made to related techniques for particulars of these components or modules.

Furthermore, for the sake of simplicity, connection relationships between the components or modules or signal profiles thereof are only illustrated in FIG. 19. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, the network device transmits the RRC reconfiguration message for adding or changing an indirect path to the remote terminal equipment via a direct path, and receives the RRC reconfiguration complete message transmitted by the remote terminal equipment via the direct path, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

### Embodiment of an Eleventh Aspect

The embodiment of this disclosure provides a multi-path communication apparatus. The apparatus may be, for example, a network device, or may be one or some components or assemblies configured in the network device, with contents identical to those in the embodiment of the fifth aspect being not going to be described herein any further.

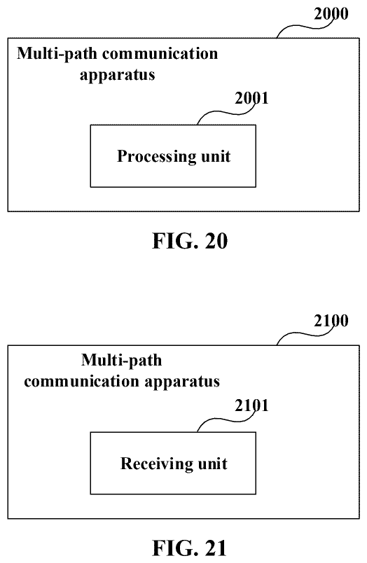

FIG. 20 is a schematic diagram of the multi-path communication apparatus of the embodiment of this disclosure. As shown in FIG. 20, the multi-path communication apparatus 2000 includes:
a processing unit 2001 configured to, in a case of a second condition or in a case where a second timer is stopped, deem that adding or changing an indirect path is successful, or execute an operation related to success of adding or changing an indirect path.

In some embodiments, the operation related to success of adding or changing an indirect path includes:
the processing unit receives an RRC reconfiguration complete message or receives uplink data via the indirect path.

In some embodiments, the second timer is stopped under the second condition, the second condition including at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

In some embodiments, the second timer is started when the remote terminal equipment receives the RRC message for adding or changing an indirect path.

In some embodiments, when the second timer expires, the processing unit deems that adding or changing an indirect path fails or executes an operation related to adding or changing an indirect path.

In some embodiments, the operation related to adding or changing an indirect path includes:
receiving failure information transmitted by the remote terminal equipment or initiating an RRC reestablishment procedure.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path communication apparatus 2000 may further include other components or modules, and reference may be made to related techniques for particulars of these components or modules.

Furthermore, for the sake of simplicity, connection relationships between the components or modules or signal profiles thereof are only illustrated in FIG. 20. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in the case of the second condition or in a case where the second timer is stopped, the network device deems that adding or changing an indirect path is successful, or the network device executes the operation related to success of adding or changing an indirect path. Therefore, the network device may determine whether the operation of adding or changing an indirect path is successful according to the second condition or the second timer, or determine whether the operation related to success of adding or changing an indirect path may be executed, thereby avoiding inappropriate operations by the network device.

### Embodiment of a Twelfth Aspect

The embodiment of this disclosure provides a multi-path communication apparatus. The apparatus may be, for example, a network device, or may be one or some components or assemblies configured in the network device, with contents identical to those in the embodiment of the sixth aspect being not going to be described herein any further.

FIG. 21 is a schematic diagram of the multi-path communication apparatus of the embodiment of this disclosure. As shown in FIG. 21, the multi-path communication apparatus 2100 includes:
a receiving unit 2101 configured to receive failure information transmitted by a terminal equipment in a case of failure in adding or changing an indirect path.

In some embodiments, the failure in adding or changing an indirect path includes:
a relay terminal equipment fails in entering a connected state;
radio resource control connection of a relay terminal equipment is rejected;
a relay terminal equipment changes a serving cell or a serving base station;
cell selection occurs in a relay terminal equipment; cell reselection occurs in a relay terminal equipment;
handover occurs in a relay terminal equipment;
a third timer expires;
PC5 connection setup fails; or
a PC5 radio link fails.

In some embodiments, the third timer is stopped under a third condition, the third condition including at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

In some embodiments, the receiving unit 2101 receives the failure information via a direct path.

In some embodiments, the failure information is transmitted after the remote terminal equipment receives a notification transmitted by the relay terminal equipment.

In some embodiments, the notification includes at least one of the following:
an RRC connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

In some embodiments, the failure information is included in an RRC message or an indication of a lower layer.

In some embodiments, the RRC message includes at least one of the following:
a sidelink UE information message;
an SCG failure information message; or
a new RRC message.

In some embodiments, the indication of a low layer may include at least one of the following:
a PDCP control PDU;
an RLC control PDU, or
an MAC CE.

In some embodiments, the failure information includes a failure type and/or a failure cause.

In some embodiments, the failure type and/or the failure cause include(s) at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment; handover occurs in a relay terminal equipment;
a third timer expires;
PC5 connection setup fails; or
a PC5 resource link fails.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path communication apparatus 2100 may further include other components or modules, and reference may be made to related techniques for particulars of these components or modules.

Furthermore, for the sake of simplicity, connection relationships between the components or modules or signal profiles thereof are only illustrated in FIG. 21. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

According to the above embodiment, in a case of failure in adding or changing an indirect path, the network device receives the failure information transmitted by the remote terminal equipment, which is helpful for the network device to learn whether the remote terminal equipment successfully adds or changes the indirect path, so that the remote terminal equipment and the network device have consistent understanding of the configuration of the remote terminal equipment, thereby avoiding subsequent configuration conflicts or configuration errors.

### Embodiment of a Thirteenth Aspect

The embodiment of this disclosure provides a communication system, and reference may be made to FIG. 1, with contents identical to those in the embodiments of the first to the twelfth aspects being not going to be described herein any further.

In some embodiments, the communication system 100 may include: a remote terminal equipment 101 and/or a relay terminal equipment 102 and/or a network device 103.

In the embodiment of this disclosure, the remote terminal equipment 101 may be configured to carry out the multi-path communication method in the embodiment(s) of the first aspect and/or the second aspect and/or the third aspect, the contents of which being incorporated herein, which shall not be described herein any further.

In the embodiment of this disclosure, the network device 103 may be configured to carry out the multi-path communication method in the embodiment(s) of the fourth aspect and/or the fifth aspect and/or the sixth aspect, the contents of which being incorporated herein, which shall not be described herein any further.

The embodiment of this disclosure further provides a remote terminal equipment.

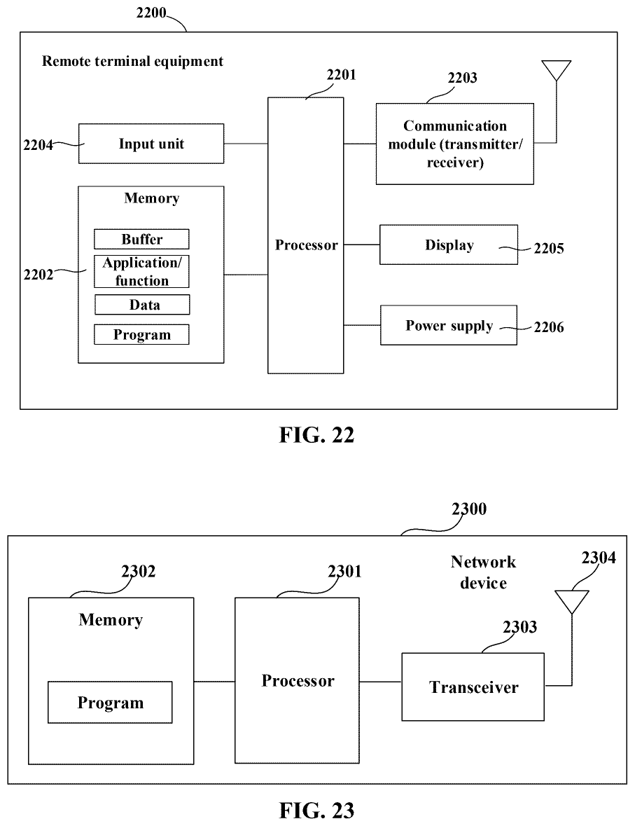

FIG. 22 is a schematic diagram of a structure of the terminal equipment of the embodiment of this disclosure. The terminal equipment may be a remote terminal equipment. As shown in FIG. 22, the terminal equipment 2200 may include a processor 2201 and a memory 2202, the memory 2202 storing data and a program and being coupled to the processor 2201. It should be noted that this figure is illustrative only, and other types of structures may also be used, so as to supplement or replace this structure and achieve a telecommunications function or other functions.

For example, the processor 2201 may be configured to execute a program to carry out the multi-path communication method in the embodiment of the first aspect. For example, the processor 2201 may be configured to executed the following operations: receiving, by the remote terminal equipment via a direct path, an RRC reconfiguration message for adding or changing an indirect path transmitted by a network device; and
transmitting an RRC reconfiguration complete message by the remote terminal equipment to the network device via the direct path.

For another example, the processor 2201 may be configured to execute a program to carry out the multi-path communication method in the embodiment of the second aspect. For example, the processor 2201 may be configured to executed the following operations: in a case of a second condition or in a case where a second timer is stopped, deeming by the remote terminal equipment that adding or changing an indirect path is successful, or executing an operation related to success of adding or changing an indirect path by the remote terminal equipment.

For a further example, the processor 2201 may be configured to execute a program to carry out the multi-path communication method in the embodiment of the third aspect. For example, the processor 2201 may be configured to executed the following operations: in a case of failure in adding or changing an indirect path, transmitting failure information by the remote terminal equipment to a network device or initiating an RRC reestablishment procedure.

As shown in FIG. 22, the terminal equipment 2200 may further include a communication module 2203, an input unit 2204, a display 2205, and a power supply 2206; wherein functions of the above components are similar to those in the related art, which shall not be described herein any further. It should be noted that the terminal equipment 2200 does not necessarily include all the parts shown in FIG. 22, and the above components are not necessary. Furthermore, the terminal equipment 2200 may include parts not shown in FIG. 22, and the related art may be referred to.

The embodiment of this disclosure further provides a network device, which may be, for example, a base station. However, this disclosure is not limited thereto, and it may also be another network device.

FIG. 23 is a schematic diagram of a structure of the network device of the embodiment of the seventh aspect of this disclosure. As shown in FIG. 23, the network device 2300 may include a processor 2301 (such as a central processing unit (CPU)) and a memory 2302, the memory 2302 being coupled to the processor 2301. Wherein, the memory 2302 may store various data, and furthermore, it may store a program for information processing, and execute the program under control of the processor 2301.

For example, the processor 2301 may be configured to execute a program to carry out the multi-path communication method in the embodiment of the fourth aspect. For example, the processor 2301 may be configured to executed the following operations: transmitting an RRC reconfiguration message for adding or changing an indirect path by the network device to a remote terminal equipment via a direct path; and
receiving by the network device via the direct path, an RRC reconfiguration complete message transmitted by the remote terminal equipment.

For another example, the processor 2301 may be configured to execute a program to carry out the multi-path communication method in the embodiment of the fifth aspect. For example, the processor 2301 may be configured to executed the following operations: in a case of a second condition or in a case where a second timer is stopped, deeming by the network device that adding or changing an indirect path is successful, or executing an operation related to success of adding or changing an indirect path by the network device.

For a further example, the processor 2301 may be configured to execute a program to carry out the multi-path communication method in the embodiment of the sixth aspect. For example, the processor 2301 may be configured to executed the following operations: receiving, by the network device, failure information transmitted by a remote terminal equipment in a case of failure in adding or changing an indirect path.

Furthermore, as shown in FIG. 23, the network device 2300 may include a transceiver 2303, and an antenna 2305, etc. Wherein, functions of the above components are similar to those in the related art, and shall not be described herein any further. It should be noted that the network device 2300 does not necessarily include all the parts shown in FIG. 23, and furthermore, the network device 2300 may include parts not shown in FIG. 23, and the related art may be referred to.

An embodiment of this disclosure provides a computer readable program code, which, when executed in a remote terminal equipment, will cause a computer to carry out the multi-path communication method as described in the embodiment(s) of the first aspect and/or the second aspect and/or the third aspect in the remote terminal equipment.

An embodiment of this disclosure provides a computer readable medium, including a computer readable program code, which will cause a computer to carry out the multi-path communication method as described in the embodiment(s) of the first aspect and/or the second aspect and/or the third aspect in a remote terminal equipment.

An embodiment of this disclosure provides a computer readable program code, which, when executed in a network device, will cause a computer to carry out the multi-path communication method as described in the embodiment(s) of the fourth aspect and/or the fifth aspect and/or the sixth aspect in the network device.

An embodiment of this disclosure provides a computer readable medium, including a computer readable program code, which will cause a computer to carry out the multi-path communication method as described in the embodiment(s) of the fourth aspect and/or the fifth aspect and/or the sixth aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to implementations containing the above embodiments, following supplements are further disclosed.

### Methods at a Remote Terminal Equipment Side

1. A multi-path communication method, applicable to a remote terminal equipment, the method including:
receiving, by the remote terminal equipment via a direct path, an RRC reconfiguration message for adding or changing an indirect path transmitted by a network device; and
transmitting an RRC reconfiguration complete message by the remote terminal equipment to the network device via the direct path.

2. The method according to supplement 1, wherein the RRC reconfiguration complete message is transmitted at one of the following times:
after the remote terminal equipment executes corresponding configurations according to the RRC reconfiguration message;
after PC5 connection between the remote terminal equipment and a relay terminal equipment is set up;
after the remote terminal equipment transmits a PC5-RRC message to a relay terminal equipment;
after the remote terminal equipment transmits PC5-RRC trigger to a relay terminal equipment;
after the remote terminal equipment receives indication information transmitted by a relay terminal equipment; or
after a first timer used for a procedure of adding or changing an indirect path is stopped.

3. The method according to supplement 2, wherein the PC5-RRC message includes at least one of the following:
RemoteUEInformationSidelink,
RRCReconfigurationSidelink
RRCReconfigurationCompleteSidelink
UEAssistanceInformationSidelink, or
a new PC5-RRC message.

4. The method according to supplement 2, wherein
the PC5-RRC trigger is used to cause the relay terminal equipment to enter an RRC_Connected state.

5. The method according to supplement 2, wherein,
the indication information includes information that the relay terminal equipment enters the RRC_Connected state.

6. The method according to supplement 2, wherein
the first timer is started when the remote terminal equipment receives the RRC reconfiguration message for adding or changing an indirect path.

7. The method according to supplement 2, wherein
the first timer is stopped under a first condition, the first condition including at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment set up PC5 connection with the relay terminal equipment; or
the remote terminal equipment receives indication information transmitted by the relay terminal equipment.

8. The method according to supplement 7, wherein the PC5-S message includes at least one of the following:
a discovery-related message; or
a direct communication request/response message.

9. The method according to supplement 8, wherein the discovery-related message includes at least one of the following:
a discovery solicitation, or
a discovery response.

10. The method according to supplement 1, wherein the method further includes:
transmitting the RRC reconfiguration complete message by the remote terminal equipment via an indirect path after the remote terminal equipment establishes PC5 connection with the relay terminal equipment.

11. A multi-path communication method, applicable to a remote terminal equipment, the method including:
in a case of a second condition or in a case where a second timer is stopped, deeming by the remote terminal equipment that adding or changing an indirect path is successful, or executing an operation related to success of adding or changing an indirect path by the remote terminal equipment.

12. The method according to supplement 11, wherein the operation related to success of adding or changing an indirect path includes:
an RRC layer of the remote terminal equipment submits an RRC reconfiguration complete message to a lower layer for transmission, or transmits uplink data via the indirect path.

13. The method according to supplement 11, wherein the second timer is stopped under the second condition, the second condition including at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

14. The method according to supplement 11, wherein,
the second timer is started when the remote terminal equipment receives the RRC message for adding or changing an indirect path.

15. The method according to supplement 11, wherein,
when the second timer expires, the remote terminal equipment deems that adding or changing an indirect path fails or executes an operation related to failure in adding or changing an indirect path.

16. The method according to supplement 15, wherein the operation related to failure of adding or changing an indirect path includes:
transmitting failure information to a network device or initiating a radio resource control reestablishment procedure.

17. A multi-path communication method, applicable to a remote terminal equipment, the method including:
in a case of failure in adding or changing an indirect path, transmitting failure information by the remote terminal equipment to a network device or initiating an RRC reestablishment procedure.

18. The method according to supplement 17, wherein the failure in adding or changing an indirect path includes:
a relay terminal equipment fails in entering a connected state;
radio resource control connection of a relay terminal equipment is rejected;
a relay terminal equipment changes a serving cell or a serving base station;
cell selection occurs in a relay terminal equipment;
cell reselection occurs in a relay terminal equipment;
handover occurs in a relay terminal equipment; a third timer expires;
PC5 connection setup fails; or
a PC5 radio link fails.

19. The method according to supplement 18, wherein the third timer is stopped under a third condition, the third condition including at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

20. The method according to supplement 17, wherein,
the failure information is transmitted after the remote terminal equipment receives a notification transmitted by the relay terminal equipment.

21. The method according to supplement 20, wherein the notification includes at least one of the following:
an RRC connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

22. The method according to supplement 17, wherein,
the failure information is included in an RRC message or an indication of a low layer.

23. The method according to supplement 22, wherein,
the RRC message includes at least one of the following:
a sidelink UE information message;
an SCG failure information message; or
a new RRC message.

24. The method according to supplement 22, wherein,
the indication of a low layer includes at least one of the following:
a PDCP control PDU;
an RLC control PDU; or
an MAC CE.

25. The method according to supplement 17, wherein,
the failure information includes a failure type and/or a failure cause.

26. The method according to supplement 25, wherein the failure type and/or the failure cause include(s) at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment;
handover occurs in a relay terminal equipment; a third timer expires;
PC5 connection setup fails; or
a PC5 resource link fails.

27. The method according to supplement 17, wherein the method further includes:
in a case where adding or changing an indirect path fails, using a previous single-path configuration, or using configuration of a direct path in a message for adding or changing an indirect path, or using a default configuration, by the remote terminal equipment.

28. The method according to supplement 17, wherein the method further includes:
keeping PC5-RRC connection by the remote terminal equipment with the relay terminal equipment or releasing the PC5-RRC connection with the relay terminal equipment; and/or,
initiating relay reselection or transmitting a discovery-related message by the remote terminal equipment; and/or,
reporting information on other relay terminal equipments by the remote terminal equipment to the network device.

29. The method according to supplement 28, wherein the information on other relay terminal equipments includes:
identifiers of the other relay terminal equipments and/or measurement results of the other relay terminal equipments.

### Apparatuses at a Network Device Side

1. A multi-path communication apparatus, applicable to a network device, the apparatus including:
a transmitting unit configured to transmit an RRC reconfiguration message for adding or changing an indirect path to a remote terminal equipment via a direct path; and
a receiving unit configured to receive via the direct path, an RRC reconfiguration complete message transmitted by the remote terminal equipment.

2. The apparatus according to supplement 1, wherein the RRC reconfiguration complete message is transmitted in at least one of the following times:
after the remote terminal equipment performs corresponding configuration according to the RRC reconfiguration message;
after the remote terminal equipment establishes PC5 connection with the relay terminal equipment;
after the remote terminal equipment transmits a PC5-RRC message to the relay terminal equipment;
after the remote terminal equipment transmits a PC5-RRC trigger to the relay terminal equipment;
after the remote terminal equipment receives indication information transmitted by the relay terminal equipment; or
after a first timer used for a procedure of adding or changing an indirect path is stopped.

3. The apparatus according to supplement 2, wherein the PC5-RRC message includes at least one of the following:
RemoteUEInformationSidelink;
RRCReconfigurationSidelink;
RRCReconfigurationCompleteSidelink;
UEAssistanceInformationSidelink; or
a new PC5-RRC message.

4. The apparatus according to supplement 2, wherein,
the PC5-RRC trigger is used to cause the relay terminal equipment to enter an RRC_Connected state.

5. The apparatus according to supplement 2, wherein,
the indication information includes information that the relay terminal equipment enters the RRC_Connected state.

6. The apparatus according to supplement 2, wherein,
the first timer is started when the remote terminal equipment receives the RRC reconfiguration message for adding or changing an indirect path.

7. The apparatus according to supplement 2, wherein,
the first timer is stopped under a first condition, the first condition including at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment set up PC5 connection with the relay terminal equipment; or
the remote terminal equipment receives indication information transmitted by the relay terminal equipment.

8. The apparatus according to supplement 7, wherein the PC5-S message includes at least one of the following:
a discovery-related message; or
a direct communication request/response message.

9. The apparatus according to supplement 8, wherein the discovery-related message includes at least one of the following:
a discovery solicitation, or
a discovery response.

10. The apparatus according to supplement 1, wherein after the remote terminal equipment establishes PC5 connection with the relay terminal equipment, the receiving unit receives via an indirect path the RRC reconfiguration complete message transmitted by the remote terminal equipment.

11. A multi-path communication apparatus, applicable to a network device, the apparatus including:
a processing unit configured to, in a case of a second condition or in a case where a second timer is stopped, deem that adding or changing an indirect path is successful, or execute an operation related to success of adding or changing an indirect path.

12. The apparatus according to supplement 11, wherein the operation related to success of adding or changing an indirect path includes:
the processing unit receives an RRC reconfiguration complete message or receives uplink data via the indirect path.

13. The apparatus according to supplement 11, wherein the second timer is stopped under the second condition, the second condition including at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

14. The apparatus according to supplement 11, wherein,
the second timer is started when the remote terminal equipment receives the RRC message for adding or changing an indirect path.

15. The apparatus according to supplement 11, wherein,
when the second timer expires, the processing units deems that adding or changing an indirect path fails or executes an operation related to adding or changing an indirect path.

16. The apparatus according to supplement 15, wherein the operation related to adding or changing an indirect path includes:
receiving failure information transmitted by the remote terminal equipment or initiating an RRC reestablishment procedure.

17. A multi-path communication apparatus, applicable to a network device, the apparatus including:
a receiving unit configured to receive failure information transmitted by a remote terminal equipment in a case of failure in adding or changing an indirect path.

18. The apparatus according to supplement 17, wherein the failure in adding or changing an indirect path includes:
a relay terminal equipment fails in entering a connected state;
radio resource control connection of a relay terminal equipment is rejected;
a relay terminal equipment changes a serving cell or a serving base station;
cell selection occurs in a relay terminal equipment; cell reselection occurs in a relay terminal equipment;
handover occurs in a relay terminal equipment;
a third timer expires;
PC5 connection setup fails; or
a PC5 radio link fails.

19. The apparatus according to supplement 18, wherein the third timer is stopped under a third condition, the third condition including at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

20. The apparatus according to supplement 17, wherein,
the failure information is transmitted after the remote terminal equipment receives a notification transmitted by the relay terminal equipment.

21. The apparatus according to supplement 20, wherein the notification includes at least one of the following:
an RRC connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

22. The apparatus according to supplement 17, wherein,
the failure information is included in an RRC message or an indication of a lower layer.

23. The apparatus according to supplement 22, wherein,
the RRC message includes at least one of the following:
a sidelink UE information message;
an SCG failure information message; or
a new RRC message.

24. The apparatus according to supplement 22, wherein,
the indication of a low layer may include at least one of the following:
a PDCP control PDU;
an RLC control PDU, or
an MAC CE.

25. The apparatus according to supplement 17, wherein,
the failure information includes a failure type and/or a failure cause.

26. The apparatus according to supplement 25, wherein the failure type and/or the failure cause include(s) at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment; handover occurs in a relay terminal equipment;
a third timer expires;
PC5 connection setup fails; or
a PC5 resource link fails.

### Methods at a Network Device Side

1. A multi-path communication method, applicable to a network device, the method including:
transmitting an RRC reconfiguration message for adding or changing an indirect path by the network device to a remote terminal equipment via a direct path; and
receiving by the network device via the direct path, an RRC reconfiguration complete message transmitted by the remote terminal equipment.

2. The method according to supplement 1, wherein the RRC reconfiguration complete message is transmitted in at least one of the following times:
after the remote terminal equipment performs corresponding configuration according to the RRC reconfiguration message;
after the remote terminal equipment establishes PC5 connection with the relay terminal equipment;
after the remote terminal equipment transmits a PC5-RRC message to the relay terminal equipment;
after the remote terminal equipment transmits a PC5-RRC trigger to the relay terminal equipment;
after the remote terminal equipment receives indication information transmitted by the relay terminal equipment; or
after a first timer used for a procedure of adding or changing an indirect path is stopped.

3. The method according to supplement 2, wherein the PC5-RRC message includes at least one of the following:
RemoteUEInformationSidelink;
RRCReconfigurationSidelink;
RRCReconfigurationCompleteSidelink;
UEAssistanceInformationSidelink; or
a new PC5-RRC message.

4. The method according to supplement 2, wherein,
the PC5-RRC trigger is used to cause the relay terminal equipment to enter an RRC_Connected state.

5. The method according to supplement 2, wherein,
the indication information includes information that the relay terminal equipment enters the RRC_Connected state.

6. The method according to supplement 2, wherein,
the first timer is started when the remote terminal equipment receives the RRC reconfiguration message for adding or changing an indirect path.

7. The method according to supplement 2, wherein,
the first timer is stopped under a first condition, the first condition including at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment set up PC5 connection with the relay terminal equipment; or
the remote terminal equipment receives indication information transmitted by the relay terminal equipment.

8. The method according to supplement 7, wherein the PC5-S message includes at least one of the following:
a discovery-related message; or
a direct communication request/response message.

9. The method according to supplement 8, wherein the discovery-related message includes at least one of the following:
a discovery solicitation, or
a discovery response.

10. The method according to supplement 1, wherein the method further includes:
after the remote terminal equipment establishes PC5 connection with the relay terminal equipment, receiving by the network device via an indirect path, the RRC reconfiguration complete message transmitted by the remote terminal equipment.

11. A multi-path communication method, applicable to a network device, the method including:
in a case of a second condition or in a case where a second timer is stopped, deeming by the network device that adding or changing an indirect path is successful, or executing an operation related to success of adding or changing an indirect path.

12. The method according to supplement 11, wherein the operation related to success of adding or changing an indirect path includes:
the network device receives an RRC reconfiguration complete message or receives uplink data via the indirect path.

13. The method according to supplement 11, wherein the second timer is stopped under the second condition, the second condition including at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

14. The method according to supplement 11, wherein,
the second timer is started when the remote terminal equipment receives the RRC message for adding or changing an indirect path.

15. The method according to supplement 11, wherein,
when the second timer expires, the network device deems that adding or changing an indirect path fails or executes an operation related to adding or changing an indirect path.

16. The method according to supplement 15, wherein the operation related to adding or changing an indirect path includes:
receiving failure information transmitted by the remote terminal equipment or initiating an RRC reestablishment procedure.

17. A multi-path communication method, applicable to a network device, the method including:
receiving, by the network device, failure information transmitted by a remote terminal equipment in a case of failure in adding or changing an indirect path.

18. The method according to supplement 17, wherein the failure in adding or changing an indirect path includes:
a relay terminal equipment fails in entering a connected state;
radio resource control connection of a relay terminal equipment is rejected;
a relay terminal equipment changes a serving cell or a serving base station;
cell selection occurs in a relay terminal equipment; cell reselection occurs in a relay terminal equipment;
handover occurs in a relay terminal equipment;
a third timer expires;
PC5 connection setup fails; or
a PC5 radio link fails.

19. The method according to supplement 18, wherein the third timer is stopped under a third condition, the third condition including at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

20. The method according to supplement 17, wherein,
the failure information is transmitted after the remote terminal equipment receives a notification transmitted by the relay terminal equipment.

21. The method according to supplement 20, wherein the notification includes at least one of the following:
an RRC connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

22. The method according to supplement 17, wherein,
the failure information is included in an RRC message or an indication of a lower layer.

23. The method according to supplement 22, wherein,
the RRC message includes at least one of the following:
a sidelink UE information message;
an SCG failure information message; or
a new RRC message.

24. The method according to supplement 22, wherein,
the indication of a low layer may include at least one of the following:
a PDCP control PDU;
an RLC control PDU, or
an MAC CE.

25. The method according to supplement 17, wherein,
the failure information includes a failure type and/or a failure cause.

26. The method according to supplement 25, wherein the failure type and/or the failure cause include(s) at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment; handover occurs in a relay terminal equipment;
a third timer expires;
PC5 connection setup fails; or
a PC5 resource link fails.

1. A multi-path communication apparatus, configured in a remote terminal equipment, the apparatus comprising:
a receiver configured to receive a radio resource control reconfiguration message for adding or changing an indirect path transmitted by a network device via a direct path; and
a transmitter configured to transmit a radio resource control reconfiguration complete message to the network device via the direct path,
wherein, a first timer is started when the remote terminal equipment receives the radio resource control reconfiguration message for adding or changing an indirect path; and,
the first timer is stopped under a first condition, the first condition comprising:
the remote terminal equipment receives indication information transmitted by the relay terminal equipment.

2. The apparatus according to claim 1, wherein the radio resource control reconfiguration complete message is transmitted at one of the following times:
after the remote terminal equipment executes corresponding configurations according to the radio resource control reconfiguration message;
after PC5 connection between the remote terminal equipment and a relay terminal equipment is set up;
after the remote terminal equipment transmits a PC5-RRC message to a relay terminal equipment;
after the remote terminal equipment transmits PC5-RRC trigger to a relay terminal equipment;
after the remote terminal equipment receives indication information transmitted by a relay terminal equipment; or
after a first timer used for a procedure of adding or changing an indirect path is stopped.

3. The apparatus according to claim 2, wherein the PC5-RRC message comprises at least one of the following:
a remote user equipment information sidelink (RemoteUEInformationSidelink);
a radio resource control reconfiguration sidelink (RRCReconfigurationSidelink);
a radio resource control reconfiguration complete sidelink (RRCReconfigurationCompleteSidelink);
a user equipment assistance information sidelink (UEAssistanceInformationSidelink); or
a new PC5 RRC message;
and/or,
the PC5-RRC trigger is used to cause the relay terminal equipment to enter a radio resource control connected state;
and/or,
the indication information comprises information that the relay terminal equipment enters a radio resource control connected state.

4. The apparatus according to claim 2, wherein,
the first timer is stopped under a first condition, the first condition further comprising at least one of the following:
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment; or
the remote terminal equipment set up PC5 connection with the relay terminal equipment.

5. The apparatus according to claim 4, wherein the PC5-S message comprises at least one of the following:
a discovery-related message; or
a direct communication request/response message.

6. The apparatus according to claim 1, wherein,
after the remote terminal equipment sets up the PC5 connection with the relay terminal equipment, the transmitter further transmits the radio resource control reconfiguration complete message via an indirect path.

7. A multi-path communication apparatus, applicable to a remote terminal equipment, the apparatus comprising:
processor circuitry configured to, in a case of a second condition or in a case where a second timer is stopped, deem that adding or changing an indirect path is successful, or execute an operation related to success of adding or changing an indirect path.

8. The apparatus according to claim 7, wherein the operation related to success of adding or changing an indirect path comprises:
a radio resource control layer of the remote terminal equipment submits a radio resource control reconfiguration complete message to a lower layer for transmission, or transmits uplink data via the indirect path.

9. The apparatus according to claim 7, wherein the second timer is stopped under the second condition, the second condition comprising at least one of the following:
the radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment;
and/or,
the second timer is started when the remote terminal equipment receives a radio resource control message for adding or changing an indirect path.

10. The apparatus according to claim 7, wherein,
when the second timer expires, the processor circuitry deems that adding or changing an indirect path fails, or performs an operation related to failure of adding or changing an indirect path.

11. The apparatus according to claim 10, wherein the operation related to failure of adding or changing an indirect path comprises:
transmitting failure information to a network device or initiating a radio resource control reestablishment procedure.

12. A multi-path communication apparatus, applicable to a remote terminal equipment, the apparatus comprising:
processor circuitry configured to, in a case of failure in adding or changing an indirect path, transmit failure information to a network device or initiate a radio resource control reestablishment procedure,
wherein the failure in adding or changing an indirect path comprises:
a relay terminal equipment changes a serving cell, or
a third timer expires.

13. The apparatus according to claim 12, wherein the failure in adding or changing an indirect path further comprises:
a relay terminal equipment fails in entering a connected state;
radio resource control connection of a relay terminal equipment is rejected;
a relay terminal equipment changes a serving base station;
cell selection occurs in a relay terminal equipment;
cell reselection occurs in a relay terminal equipment;
handover occurs in a relay terminal equipment;
PC5 connection setup fails; or
a PC5 radio link fails.

14. The apparatus according to claim 13, wherein the third timer is stopped under a third condition, the third condition comprising at least one of the following:
a radio resource control reconfiguration complete message is successfully transmitted;
the remote terminal equipment transmits a PC5-RRC message to the relay terminal equipment;
the remote terminal equipment transmits a PC5-S message to the relay terminal equipment;
the remote terminal equipment transmits data of a radio bearer via the relay terminal equipment;
a PC5-RRC message and/or a PC5-S message is/are successfully transmitted to the relay terminal equipment;
the remote terminal equipment sets up PC5 connection with the relay terminal equipment; or
the remote terminal equipment receives indication information transmitted by the relay terminal equipment.

15. The apparatus according to claim 12, wherein,
the failure information is transmitted after the remote terminal equipment receives a notification transmitted by the relay terminal equipment.

16. The apparatus according to claim 15, wherein the notification comprises at least one of the following:
a radio resource control connection setup or recovery procedure of the relay terminal equipment fails or is rejected;
cell reselection or handover occurs in the relay terminal equipment;
a discovery message of the relay terminal equipment, a serving cell of the relay terminal equipment included in the discovery message being different from a serving cell to which the remote terminal equipment is connected via a direct path, or a serving base station of the relay terminal equipment included in the discovery message being different from a serving base station to which the remote terminal equipment is connected via a direct path.

17. The apparatus according to claim 12, wherein,
the failure information is included in a radio resource control message or an indication of a low layer.

18. The apparatus according to claim 17, wherein,
the radio resource control message comprises at least one of the following:
a sidelink UE information message;
a secondary cell group failure information (SCG failure information) message; or
a new radio resource control message;
and/or,
the indication of a low layer comprises at least one of the following:
a packet data aggregation protocol control protocol data unit (PDCP control PDU);
a radio link control protocol data unit (RLC control PDU); or
a media access control control element (MAC CE).

19. The apparatus according to claim 12, wherein,
the failure information comprises a failure type and/or a failure cause, the failure type and/or the failure cause comprising at least one of the following:
the relay terminal equipment fails in entering a connected state;
radio resource control connection of the relay terminal equipment is rejected;
the relay terminal equipment changes a serving cell or a serving base station;
cell selection occurs in a relay terminal equipment;
cell reselection occurs in a relay terminal equipment;
handover occurs in a relay terminal equipment;
a third timer expires;
PC5 connection setup fails; or
a PC5 resource link fails.

20. The apparatus according to claim 12, wherein,
in a case where adding or changing an indirect path fails, the processor circuitry uses a previous single-path configuration, or uses configuration of a direct path in a message for adding or changing an indirect path, or uses a default configuration; and/or,
the processor circuitry keeps PC5-RRC connection with the relay terminal equipment or releases the PC5-RRC connection with the relay terminal equipment; and/or,
the processor circuitry initiates relay reselection or transmits a discovery-related message; and/or,
the processor circuitry reports information on other relay terminal equipments to the network device.
